(19) United States
(12) Patent Application Publication
(10) Pub. No.: US 2015/0226527 A1
(43) Pub. Date: Aug. 13, 2015

(54) ARMOR COMPONENTS AND METHOD OF FORMING SAME

(71) Applicant: Saint-Gobain Ceramics & Plastics, Inc., Worcester, MA (US)

(72) Inventors: Stephen BOTTIGLIERI, Northborough, MA (US); Abhaya K. BAKSHI, Westford, MA (US)

(73) Assignee: Saint-Gobain Ceramics & Plastics, Inc., Worcester, MA (US)

(21) Appl. No.: 14/292,129

(22) Filed: May 30, 2014

Related U.S. Application Data
(60) Provisional application No. 61/829,044, filed on May 30, 2013.

(51) Int. Cl. F41H 5/007; B63G 13/00; B64D 7/00; B22F 5/00; F41H 5/06; B22F 3/02; B22F 3/10; B22F 3/14; F41H 1/02; F41H 5/24

(52) U.S. Cl. CPC F41H 5/007; F41H 1/02; B63G 13/00; B64D 7/00; F41H 5/24; F41H 5/06; B22F 3/02; B22F 3/10; B22F 3/14; B22F 5/00

(57) ABSTRACT

An armor component including a body including a material component configured to undergo a phase change upon a projectile impact. The material component may also have a ready state defining a first lattice structure configured to change from the ready state to an absorbed state defining a second lattice structure different from the first lattice structure. The material component may also have a ready state defining a first density and configured to change from the ready state to an absorbed state defining a second density, wherein the first density is less than the second density. In a particular aspect, the material component, in combination with a first component on or adjacent to the material component, can be configured to prevent pentration of a projectile having an energy of 4,000 J upon impact with a strikeface of the material component.

### CROSS-REFERENCE TO RELATED APPLICATION

This application claims priority under 35 U.S.C. §119(e) to U.S. Patent Application No. 61/829,044 entitled “ARMOR COMPONENTS AND METHOD OF FORMING SAME,” by Stephen Bottiglieri, et al., filed May 30, 2013, which is assigned to the current assignee hereof and incorporated herein by reference in its entirety.

### BACKGROUND

1. Field of the Disclosure

The following is directed to armor components, and particularly, armor components comprising a ceramic component configured to undergo a phase change upon sufficient impact from a projectile.

2. Description of the Related Art

Armor and other protective materials are usually formed from a series of components, each comprising a plurality of layers of one or more different materials. Such materials, such as ceramics, are typically used for their preferential mechanical characteristics, such as, for example, hardness and density. Materials such as, for example, silicon carbide and cubic boron nitride, have been previously employed in body armor plates. Still, there is a need in the art for improved armor components.

### BRIEF DESCRIPTION OF THE DRAWINGS

The present disclosure may be better understood, and its numerous features and advantages made apparent to those skilled in the art by referencing the accompanying drawings.

FIG. 1 includes a perspective illustration of a portion of an armor component in accordance with an embodiment.

FIG. 2 includes a cross-sectional illustration of a portion of an armor component in accordance with an embodiment.

FIG. 3 includes a cross-sectional illustration of a portion of an armor component in accordance with an embodiment.

FIG. 4 includes a cross-sectional illustration of a portion of an armor component in accordance with an embodiment.

FIG. 5 includes a cross-sectional illustration of a portion of an armor component in accordance with an embodiment.

FIG. 6 includes test results of testing performed on an armor component in accordance with an embodiment.

FIG. 7 includes test results of testing performed on an armor component in accordance with an embodiment.

FIG. 8 includes test results of testing performed on an armor component in accordance with an embodiment.

FIG. 9(a) includes a perspective illustration of a portion of a platelet having a hexagonal microstructure and having basal planes aligned along a single plane.

FIG. 9(b) includes a perspective illustration of hexagonally-shaped platelets stacked upon each other with their respective basal planes oriented generally parallel to each other.

FIG. 10 is a graph illustrating the results of XRD analysis to determine platelet orientation of embodiments disclosed herein.

FIG. 11 is a graph illustrating the results of XRD analysis to determine platelet orientation of embodiments disclosed herein different than the embodiments of FIG. 10.

### DETAILED DESCRIPTION

The following is directed to processes that may be suitable for forming ceramic components, which may be useful in a variety of applications. Furthermore, the following includes description of articles including ceramic components, which may be useful in certain applications, including, for example, armor components.

In one aspect, a method for making an armor component can be initiated at a first step that includes providing a ceramic powder. The ceramic powder may include a material selected from the group of oxides, nitrides, borides, carbides, and a combination thereof. In particular instances, the ceramic powder can include a nitride, such as boron nitride (BN). In more particular instances, the ceramic powder can include hexagonal boron nitride (h-BN), which can include boron nitride having a hexagonal lattice structure.

It will be appreciated that the ceramic powder may include a mixture of materials. For example, the ceramic powder can include hexagonal boron nitride and at least one other ceramic material including, for example, an oxide. In particular instances, the ceramic powder can include hexagonal boron nitride and at least one oxide material including, for example, silica. More particularly, the ceramic powder may include a mixture of hexagonal boron nitride, which may be present in a majority content relative to any other components within the ceramic powder, and an oxide, which may be present in a non-impurity amount sufficient to facilitate formation of the ceramic component for use as an armor component. Alternatively, the ceramic powder may include a mixture of hexagonal boron nitride, which may be present in a minority content relative to any other components within the ceramic powder, and an oxide, which may be present in a non-impurity amount sufficient to facilitate formation of the ceramic component for use as an armor component.

In particular instances, the process of providing the ceramic powder can include forming a ceramic powder to have a coating. In more particular instances, the ceramic powder may include individual composite particles. For example, in one particular embodiment, the ceramic powder may include individual composite particles having a core-shell structure, wherein the shell may be in the form of a coating overlying at least a portion of the core.

In accordance with an embodiment, the core of the core-shell structure may include a first material, and the shell (i.e., coating) of the core-shell structure may include a second material different than the first material. For example, the core material may include a ceramic material, such as hexagonal boron nitride, and the shell material may include a ceramic, glass, polymer, natural material, and a combination thereof. In more particular instances, the coating can include a material, such as an oxide, nitride, boride, carbide, and any combination thereof. In more particular embodiments, the coating can include an oxide, such as silica, and more particularly, may consist essentially of silica. In still other particular embodiments, the coating can include fumed silica.

In accordance with an embodiment, the material of the shell, or coating, may have a shell coefficient of thermal expansion (CTEₛₕₑₗₗ) and the material of the core may have a core coefficient of thermal expansion (CTE_{core}). In certain instances, the shell CTE can be substantially the same as the core CTE. In other instances, the shell CTE can be significantly different than the core CTE.

For example, in accordance with an embodiment, the shell CTE (i.e., CTEₛₕₑₗₗ) may be at least about 1% less than the core CTE (i.e., CTE_{core}), as measured by the equation [(CTE_{core}−CTEₛₕₑₗₗ)/CTE_{core}]×100%. It will be appreciated that the percent difference in CTE can be measured as the absolute value of the equation noted herein. In accordance with particular instances, the shell CTE can be at least about 2% less than the core CTE, that is, at least about 3% less, at least about 4% less, at least about 5% less, at least about 6% less, at least about 7% less, at least about 8% less, at least about 9% less, at least about 10% less, at least about 12% less, at least about 15% less, at least about 20% less, at least about 25% less, at least about 30% less, at least about 35% less, at least about 40% less, at least about 45% less, at least about 50% less, at least about 55% less, at least about 60% less, at least about 65% less, at least about 70% less, at least about 75% less, at least about 80% less, at least about 85% less, at least about 90% less, at least about 95% less, or even at least about 98% less. In accordance with an embodiment, the shell CTE may be not greater than about 1% the value of the core CTE, such as not greater than about 2%, not greater than about 3%, not greater than about 4%, not greater than about 5%, not greater than about 6%, not greater than about 7%, not greater than about 8%, not greater than about 9%, not greater than about 10%, not greater than about 12%, not greater than about 15%, not greater than about 20%, not greater than about 25%, not greater than about 30%, not greater than about 35%, not greater than about 40%, not greater than about 45%, not greater than about 50%, not greater than about 55%, not greater than about 60%, not greater than about 65%, not greater than about 70%, not greater than about 75%, not greater than about 80%, not greater than about 85%, not greater than about 90%, not greater than about 95%, not greater than about 98%, or even not greater than about 99%. It will be appreciated that the difference in CTE between the shell, or coating, and the core can be within a range between any of the minimum and maximum percentages noted above.

In accordance with another embodiment, the core CTE (i.e., CTE_{core}) may be at least about 1% less than the shell CTE (i.e., CTEₛₕₑₗₗ), as measured by the equation [(CTEₛₕₑₗₗ−CTE_{core})/CTEₛₕₑₗₗ]×100%. It will be appreciated that the difference in CTE can be measured as the absolute value of the equation noted herein. In accordance with particular instances, the core CTE can be at least about 2% less than the shell CTE, that is, at least about 3% less, at least about 4% less, at least about 5% less, at least about 6% less, at least about 7% less, at least about 8% less, at least about 9% less, at least about 10% less, at least about 12% less, at least about 15% less, at least about 20% less, at least about 25% less, at least about 30% less, at least about 35% less, at least about 40% less, at least about 45% less, at least about 50% less, at least about 55% less, at least about 60% less, at least about 65% less, at least about 70% less, at least about 75% less, at least about 80% less, at least about 85% less, at least about 90% less, at least about 95% less, at least about 98% less, or even at least about 99% less. In accordance with an embodiment, the core CTE may be not greater than about 1% the value of the shell CTE, such as not greater than about 2%, not greater than about 3%, not greater than about 4%, not greater than about 5%, not greater than about 6%, not greater than about 7%, not greater than about 8%, not greater than about 9%, not greater than about 10%, not greater than about 12%, not greater than about 15%, not greater than about 20%, not greater than about 25%, not greater than about 30%, not greater than about 35%, not greater than about 40%, not greater than about 45%, not greater than about 50%, not greater than about 55%, not greater than about 60%, not greater than about 65%, not greater than about 70%, not greater than about 75%, not greater than about 80%, not greater than about 85%, not greater than about 90%, not greater than about 95%, not greater than about 98%, or even not greater than about 99%. It will be appreciated that the difference in CTE between the shell, or coating, and the core can be within a range between any of the minimum and maximum percentages noted above.

In particular embodiments, the coating can include a material having a coefficient of thermal expansion (CTE) of not greater than about 3×10⁻⁶° C.⁻¹.

In accordance with an embodiment, the ceramic powder can have an average particle size that is not greater than about 500 microns. In other embodiments, the average particle size, which may also be considered the median particle size (D₅₀), may be not greater than about 400 microns, such as not greater than about 300 microns, not greater than about 200 microns, not greater than about 100 microns, not greater than about 80 microns, not greater than about 50 microns, or even not greater than about 10 microns. Still, in one non-limiting embodiment, the ceramic powder may have an average particle size that can be at least about 1 nm, such as at least about 10 nm, at least about 50 nm, at least about 0.1 microns, at least about 0.5 microns, at least about 0.8 microns, at least about 1 micron, at least 3 microns, or even at least 7 microns. It will be appreciated that the ceramic powder can have an average particle size within a range between any of the minimum and maximum values noted above.

In an embodiment, the ceramic powder can have platelike grains, which can have an average particle diameter that is not greater than 50 microns, such as not greater than 25 microns, or even no greater than 10 microns. In a non-limiting embodiment, the ceramic powder may have platelike grains having an average particle diameter that can be at least 1 micron, such as at least 3 microns, at least 5 microns, or even at least 7 microns. For example, in a particular embodiment, the ceramic powder can have platelike grains having an average particle diameter within a range of from 3 microns to about 6 microns. In another embodiment, the platelike grains can have an average particle diameter within a range of from 7 microns to 10 microns.

In accordance with an embodiment, the ceramic powder can have platelike grains, which can have an average thickness of at least 0.03 microns, such as at least 0.1 microns, at least 0.2 microns, at least 0.3 microns, at least 0.6 microns, or even at least 1 micron. In a non-limiting embodiment, the platelike grains may have an average thickness of no greater than 2 microns, such as no greater than 1 micron. The platelike grains can have an average thickness within any range of minimum or maximum values indicated above, such as within a range of 0.1 microns to 0.3 microns.

In a particular embodiment, the ceramic powder can have platelike grains, which can have a diameter/thickness ratio of at least 10. For example, the platelike grains can have a diameter/thickness ratio of at least 25, such as at least 50, at least 75, or even at least 100. In a non-limiting embodiment, the platelike grains may have a diameter/thickness ratio of no greater than 200. The ceramic powder can have platelike grains having a diameter/thickness ratio within any range of minimum or maximum values indicated above, such as within a range of 10 to 100.

The ceramic powder may define a Gaussian or normal particle size distribution. In other embodiments, the ceramic powder may define a non-Gaussian particle size distribution. For example, in one embodiment the ceramic powder may define a multimodal particle size distribution, such that multiple modes of particle sizes are identified and distinct from each other. In certain instances, the ceramic powder may define a bimodal particle size distribution.

As will be appreciated, and as noted herein, the ceramic powder may include a mixture of at least two different types of powder materials having two distinct compositions. In particular instances, the ceramic powder may include a mixture, wherein each of the distinct powder compositions can define a distinct mode of the particle size distribution. For example, the ceramic powder can include a first composition defining a first mode of the particle size distribution, and a second composition having a distinct composition from the first composition and defining a second mode of the particle size distribution, wherein the second mode defines a distinct particle size relative to the first mode.

The ceramic powder may further contain limited amounts of certain impurity materials, including for example free-carbon. In particular instances, the ceramic powder may contain less than 1% carbon material, and more particularly less than 0.1%, or even less than 0.01% carbon or carbon-based material.

In accordance with another embodiment, the ceramic powder can be formed into a mixture. The mixture may include a dry mixture or a wet mixture. In particular instances, the wet mixture can be in the form of a slurry, which can include the ceramic component and a carrier, such as a liquid carrier. In particular instances, the liquid carrier may include water.

After providing the ceramic powder, the process can continue at another step, which can include forming a green body including the ceramic powder. It will be appreciated that reference to a green body is reference to an unsintered body, which may undergo further processing for complete or full densification. In accordance with an embodiment, the process of forming the ceramic powder into a green body can include processes, such as mixing, molding, casting, depositing, pressing, punching, printing, spraying, drying, sintering, and a combination thereof. In one particular embodiment, the process of forming can include creating a mixture having at least one additive. Certain suitable additives can be selected from the group of materials, such as binders, plasticizers, surfactants, sintering aids, dispersants, and a combination thereof.

In one particular embodiment, the process of creating a mixture can include forming a slurry having a pH that is particularly controlled. For example, the slurry can have a pH that is basic. In more particular instances, the slurry can have a pH of not greater than about 10, such as not greater than about 11, or not even greater than about 12. Still, in one non-limiting embodiment, the pH of the mixture can be at least about 5, such as at least about 6, at least about 7, at least about 8, or even at least about 9. It will be appreciated that in one embodiment, the mixture can have a pH within a range of any of the minimum and maximum values noted above.

As noted herein, the mixture may include the ceramic powder and an additive, which may include a sintering aid. Some suitable sintering aids can include a ceramic, a glass, a polymer, a natural material, and a combination thereof. More particularly, the sintering aid may include a metal such as nickel; or an oxide, nitride, boride, carbide, and a combination thereof.

As noted herein, the mixture can include the ceramic powder and an additive, including a dispersant. Some suitable dispersants can include polymers. In one particular embodiment, the dispersant can include ammonium polymethacrylate, available under the trade name Darvan® C though Vanderbilt Minerals, LLC of Norwalk, Conn. It will be appreciated that the mixture may include a minority content of the additive as compared to the content of ceramic powder. For example, the mixture may include a minority content of the dispersant, including a content of less than about 20 volume percent (vol %) of the total volume of the mixture.

Some suitable processes of forming the mixture into a green body can include drying, molding, and any combination thereof. In particular instances, the process of forming the mixture into the green body can include a particular drying operation, and more particularly, a freeze-drying process. It will be appreciated that the freeze-drying process may mold the mixture into a particular shape while also removing or changing the phase (e.g. freezing, melting, or evaporating or drying) of certain components from the mixture to form the green body.

In accordance with the embodiment, the green body can have any suitable shape for the desired application of the ceramic component. In one particular embodiment, the green body can be formed into a shape suitable for use as an armor component. For example, the green body may have a standardized SAPI torso plate shape. In other embodiments, the green body can be formed to have a standardized tessellated tile shape. It will be appreciated that any other shape suitable for use as an armor component may be utilized.

In accordance with an embodiment, the process of forming can include densification of the green body. Some suitable densification operations can include heating, and more particularly, a sintering operation. In one particular instance, the process of forming the final-formed ceramic component can include a hot-pressing operation. Hot-pressing can include the application of heat and pressure to the green body to facilitate densification. In certain instances, the process of hot-pressing can be conducted at a pressure of at least about 6.9 MPa (1,000 psi), such as at least about 10 MPa (1,500 psi), at least about 14 MPa (2,000 psi), or even at least about 220 MPa (3,000 psi). Still, in another non-limiting embodiment, the pressure utilized during hot-pressing can be not greater than about 70 MPa (10,000 psi), such as not greater than about 140 MPa (20,000 psi), not greater than about 340 MPa (50,000 psi), not greater than about 520 MPa (75,000 psi), not greater than about 600 MPa (90,000 psi), or even not greater than about 670 MPa (100,000 psi). It will be appreciated that the pressure utilized during hot-pressing can be within a range between any of the minimum and maximum pressures noted above.

In accordance with another embodiment, the process of hot-pressing can be conducted at a hot-pressing temperature. For example, the hot-pressing temperature can be at least about 1,500° C., such as at least about 1,700° C., or even at least about 1,900° C. Still, in one non-limiting embodiment, the hot-pressing temperature can be not be greater than about 2,000° C., such as not greater than about 2,100° C., or even not greater than about 2,200° C. It will be appreciated that the hot-pressing temperature can be within a range between any of the above minimum and maxiumum values. Furthermore, it will be appreciated that the conditions for facilitating formation (e.g., desification) of the ceramic component into a ready state for use as an armor component are contemplated and within the scope of the embodiments described herein described in accordance with the embodiments herein. For example, in an embodiment, hot-pressing may be performed at a temperature of at least about 1,600° C. and at a pressure of at least about 2,000 psi.

In another particular instance, the process of forming the final-formed ceramic component can include a pressureless sintering operation. Pressureless sintering can include the application of heat and pressure to the green body to facilitate densification. In certain instances, the process of pressureless sintering can be conducted at a pressure provided under vacuum or inert atmospheric pressures. In certain instances, the process of pressureless sintering can be conducted at a pressure of at least about 0 kPa (0 psi), such as at least about 34 kPa (5 psi), at least about 69 kPa (10 psi), at least about 9.7 kPa (14 psi), or even at least about 100 kPa (14.7 psi). Still, in another non-limiting embodiment, the pressure utilized during pressureless sintering can be not greater than about 140 kPa (20 psi), such as not greater than about 100 kPa (15 psi), not greater than about 69 kPa (10 psi), or even not greater than about 34 kPa (5 psi). It will be appreciated that the pressure utilized during pressureless sintering can be within a range between any of the minimum and maximum pressures noted above.

In accordance with another embodiment, the process of pressureless sintering can be conducted at a pressureless sintering temperature. For example, the pressureless sintering temperature can be at least about 1,400° C., such as at least about 1,450° C., at least about 1,500° C., at least about 1,700° C., or even at least about 1,900° C. Still, in one non-limiting embodiment, the pressureless sintering temperature can be not be greater than about 2,000° C., such as not greater than about 2,100° C., or even not greater than about 2,200° C. It will be appreciated that the pressureless sintering temperature can be within a range between any of the above minimum and maxiumum values. In a particular embodiment, pressurless sintering may be conducted under vacuum or inert atmospheric pressure at least about 1,600° C.

In another particular instance, the process of forming the final-formed ceramic component can include a spark plasma sintering operation. Spark plasma sintering can include the application of heat and pressure to the green body to facilitate densification. In certain instances, the process of spark plasma sintering can be conducted at a pressure of at least about 1,000 psi, such as at least about 10 MPa (1,500 psi), at least about 14 MPa (2,000 psi), or even at least about 21 MPa (3,000 psi). Still, in another non-limiting embodiment, the pressure utilized during spark plasma sintering can be not greater than about 69 MPa (10,000 psi), such as not greater than about 140 MPa (20,000 psi), not greater than about 340 MPa (50,000 psi), not greater than about 520 (75,000 psi), not greater than about 600 MPa (90,000 psi), or even not greater than about 670 MPa (100,000 psi). It will be appreciated that the pressure utilized during spark plasma sintering can be within a range between any of the minimum and maximum pressures noted above.

In accordance with another embodiment, the process of spark plasma sintering can be conducted at a spark plasma sintering temperature. For example, the spark plasma sintering temperature can be at least about 1,500° C., such as at least about 1,700° C., or even at least about 1,900° C. Still, in one non-limiting embodiment, the spark plasma sintering temperature can be not be greater than about 2,000° C., such as not greater than about 2,100° C., or even not greater than about 2,200° C. It will be appreciated that the spark plasma sintering temperature can be within a range between any of the above minimum and maxiumum values. Furthermore, it will be appreciated that the conditions for facilitating densification while also facilitating formation of the ceramic component in a ready state for use as an armor component are contemplated and within the scope of the embodiments described herein. For example, in an embodiment, spark plasma sintering may be performed at a temperature of at least about 1,600° C. and at a pressure of at least about 14 Mpa (2,000 psi).

In another embodiment, the process of forming the ceramic powder into a ceramic component can include the process of hot-pressing, which may be conducted in a controlled atmosphere. For example, hot-pressing may be conducted in an inert atmosphere. Furthermore, the content of certain impurities, including, for example, carbon within the forming chamber, may be controlled during hot-pressing. As such, in at least one embodiment, the hot-pressing process may be conducted in an atmosphere containing less than 100 ppm of carbon.

After completing the forming process, a ceramic component is formed. The ceramic component can have certain features, which are described in greater detail in accordance with the embodiments described herein.

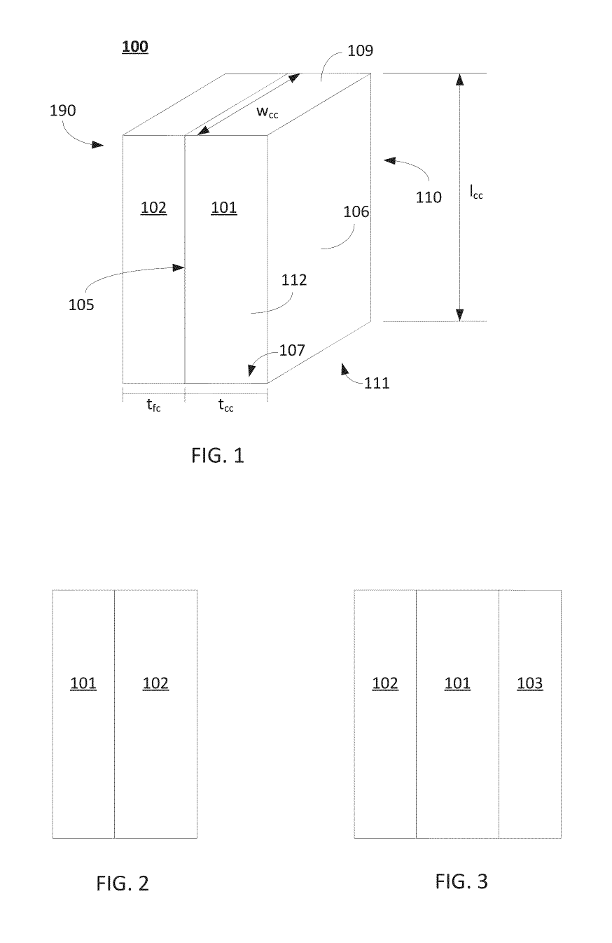

FIG. 1 includes a perspective view illustration of an armor component 100 in accordance with an embodiment. As illustrated, the armor component 100 can include a ceramic component 101 and a first component 102 on or adjacent to a face the ceramic component 101. In particular instances, the first component 102 may overlie the ceramic component 101. In other embodiments, it will be appreciated that the first component 102 may have a particular position relative to the ceramic component 101. For example, as illustrated in FIG. 2, the first component 102 may underlie the ceramic component 101. As further illustrated in FIG. 3, another construction of the armor component 100 can include a ceramic component 101 disposed between a first component 102 and a third component 103. It will be appreciated that various suitable arrangements of the ceramic component 101 relative to other components (e.g., the first component 102 and the second component 103) are contemplated and within the scope of the embodiments described herein. In a particular embodiment, as generally illustrated in FIG. 1, the first component 102 can be one or adjacent to a first major surface 105 of the ceramic component 101 that is opposite to a strikeface 106 of the ceramic component 101.

Referring again to FIG. 1, the armor component 100 can have a body 190, which includes a ceramic component 101. As further illustrated, the ceramic component 101 can have a length (l_{cc}), a width (w_{cc}), and a thickness (t_{cc}). As illustrated, the length (l_{cc}) may define the longest dimension of the body of the ceramic component 101. The width (w_{cc}) may extend in a direction perpendicular to the length (l_{cc}) and can define a second longest dimension of the body of the ceramic component 101. Furthermore, in one embodiment, the thickness (t_{cc}) of the body of the ceramic component 101 can extend in a direction perpendicular to the plane defined by the width (w_{cc}) and length (l_{cc}) of the body 190, and may further define the smallest dimension of the body of the ceramic component 101. In at least one embodiment, the ceramic component 101 can have a width (w_{cc}) that may be greater than the thickness (t_{cc}), and a length (l_{cc}) may be greater than the width (w_{cc}).

As illustrated in FIG. 1, the body 190 of the ceramic component 101 may define a generally polygonal structure. For example, as discussed briefly above, the body 190 of the ceramic component 101 can include a first major surface 105. The first major surface 105 can define an interface between the ceramic component 101 and first component 102, and a strikeface 106 opposite the first major surface 105 and spaced apart from the first major surface 105 by the dimension of thickness (t_{cc}). The strikeface 106 can be the first surface of the ceramic component 101 that is intended to come in contact with a projectile, such as a bullet. As will be appreciated, the first major surface 105 and the strikeface 106 of the body of the ceramic component 101 may be defined generally by the dimensions of length and width of the ceramic component 101. As further illustrated, the ceramic component 101 can include side surfaces 109, 110, 111, and 112 extending between the first major surface 105 and the strikeface 106 and further defining the thickness (t_{cc}) of this ceramic component 101.

In accordance with an embodiment, the ceramic component 101, and therefore the body 190, can have a two-dimensional shape. In accordance with an embodiment, and further as illustrated in FIG. 1, the ceramic component 101, and therefore, the body 190 or at least a portion of the body 190, can be in the form of a layer. Furthermore, the ceramic component 101 can be a layer having a first major surface 105 and the strikeface 106 defining a particular polygonal two-dimensional shape. In particular, the length and width of the ceramic component 101, and thus at least a portion of the body 190, can define a particular two-dimensional shape, such as a polygon, ellipsoid, circle, indicia, Roman numeral, Roman alphabet character, Kanji character, and a combination thereof. It will be appreciated that the ceramic component 101 can have a two-dimensional shape in the plane defined by the length and width of the ceramic component 101 having any suitable or desirable two-dimensional shape.

In accordance with another embodiment, the ceramic component 101, thus at least a portion of the body 190 of the armor component 100, can have a two-dimensional shape including at least four (4) distinct sides, such as, for example, a trapezoidal shape. In at least another embodiment, the ceramic component 101, at least a portion of the body 190 of the armor component 100, can have a shape including at least six (6) distinct sides. For example, as illustrated in FIG. 1, the ceramic component 101 can be in the form of a generally cube-like shape including six (6) distinct sides including the first major surface 105, a the strikeface 106, and the side surfaces 109, 110, 111, and 112. It will be appreciated, however, that in other embodiments, the ceramic component 101, and thus at least a portion of the body 190 of the armor component 100, can include a greater number of sides, including at least about 7 distinct sides, at least about 8 distinct sides, at least about 9 distinct sides, or even at least about 10 distinct sides.

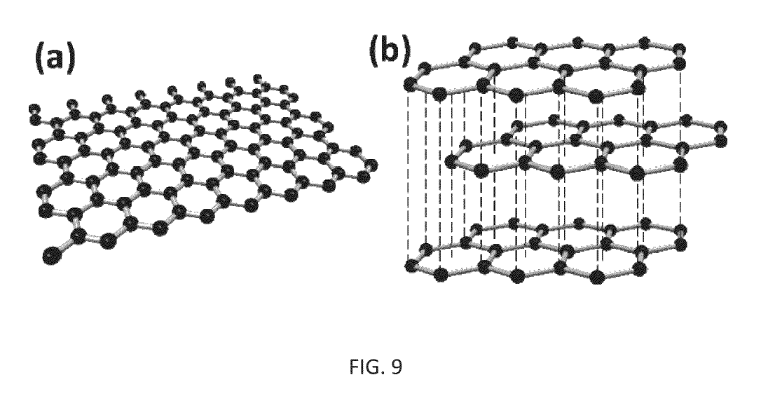

In one embodiment, the ceramic component 101 can include a material phase including a solid phase, a liquid phase, a gas phase, and a combination thereof. That is, the ceramic component 101 need not necessarily consist essentially of a solid phase material. However, it will be appreciated that in at least one embodiment, the ceramic component may consist essentially of a solid phase. In yet another embodiment, the ceramic component 101 may consist essentially of a liquid phase. In still another embodiment, the ceramic component may be formed of a mixture of phases (e.g., solid and liquid phases). More particularly, the ceramic component 101 may be a component that comprises at least a majority content of a solid phase. It will be appreciated that reference herein to the phases is reference to the state of the ceramic component 101 under standard atmospheric conditions. In accordance with an embodiment, the ceramic component 101 can include a material including grains having a particular microstructure. For example, the grains can have a platelet-shaped microstructure, which are referred to herein as platelets. In a particular instance, the platelets can be hexagonally-shaped platelets and can have basal planes. Further, in accordance with an embodiment, the platelets can be arranged in stacks, wherein the platelets are stacked upon each other such that their basal planes are oriented generally parallel to each other. FIG. 9(a) illustrates a portion of a platelet having a hexagonal microstructure and having basal planes aligned along a single plane. FIG. 9(b) illustrates hexagonally-shaped platelets stacked upon each other with their respective basal planes oriented generally parallel to each other.

In accordance with an embodiment, at least 50% of the basal planes of the platelets may be oriented within 85° of parallel to the strikeface 106. As discussed above, the strikeface 106 can be a plane defined by the width (w_{cc}) and length (l_{cc}) of the body 190. As used herein for the determination of the orientation of platelets with respect to the strikeface 106, the strikeface 106 can be defined as a plane having an area of about 0.5 cm². In this instance, it will be understood that the strikeface 106 lies substantially along a single plane. For example, within 5° within the single plane. In instances where the strikeface 106 lies along a curve, a corresponding plane representative of the strikeface can be determined as a square planar area of 0.5 cm² in which all four corners of the square planar area contact the surface of the strikeface 106. In particular instances, at least 50% of the basal planes of the platelets may be oriented within 60° of parallel to the strikeface, such as within 45° of parallel to the strikeface, within 30° of parallel to the strikeface, or even within 20° of parallel to the strikeface 106. In some instances, at least 70%, at least 90% or even at least 95% of the basal planes of the platelets may be oriented within 85° of parallel to the strikeface 106. In a particular embodiment, at least 95% of the basal planes of the platelets may be oriented within 30° of parallel to the strikeface 106. In another embodiment, at least 50% of the platelets include basal planes oriented within 30° of parallel to the corresponding plane. In accordance with an embodiment, the ceramic component 101 can include a material, such as a ceramic, which can include a compound, including a non-metal element and a metal element. In particular instances, the ceramic component 101 can include a nitride material. In more particular instances, the ceramic component 101 may include boron. For example, in one particular instance, the ceramic component 101 can include boron nitride (BN). Still, in at least one embodiment, the ceramic component 101 can include hexagonal boron nitride (h-BN), and more particularly the ceramic component 101 may consist essentially of hexagonal boron nitride. It will be appreciated that reference herein to hexagonal boron nitride is reference to boron nitride having a hexagonal lattice structure according to the Bravais lattice types. It will be appreciated that hexagonal boron nitride may also be referred to graphitic boron nitride having a generally layered structure having covalent bonds within the layer, and wherein adjacent layers can be bonded with secondary bonding mechanisms, such as van der Waals forces. Accordingly, in some instances, the hexagonal boron nitride may include grains having a generally platelet-shaped structure.

In accordance with an embodiment, the ceramic component 101 may have a content of hexagonal boron nitride that can be at least about 1%, such as at least about 2%, at least about 3%, at least about 4%, at least about 5%, at least about 6%, at least about 7%, at least about 8%, at least about 9%, at least about 10%, at least about 12%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, at least about 98%, or even at least about 99%. In accordance with another embodiment, the ceramic component 101 can have a content of hexagonal boron nitride that is not greater than about 1%, such as not greater than about 2%, not greater than about 3%, not greater than about 4%, not greater than about 5%, not greater than about 6%, not greater than about 7%, not greater than about 8%, not greater than about 9%, not greater than about 10%, not greater than about 12%, not greater than about 15%, not greater than about 20%, not greater than about 25%, not greater than about 30%, not greater than about 35%, not greater than about 40%, not greater than about 45%, not greater than about 50%, not greater than about 55%, not greater than about 60%, not greater than about 65%, not greater than about 70%, not greater than about 75%, not greater than about 80%, not greater than about 85%, not greater than about 90%, not greater than about 95%, not greater than about 98%, or even not greater than about 99%. It will be appreciated that the ceramic component 101 can have a content of hexagonal boron nitride within a range between any of the minimum and maximum percentages noted above.

In accordance with an embodiment, the ceramic component 101 may include no material other than hBN that is configured to undergo a phase change upon a projectile impact. In accordance with another embodiment, the armor component 100 may include no material other than hBN that is configured to undergo a phase change upon a projectile impact.

In accordance with an embodiment, the ceramic component 101 can have a particular density. One factor in armor, such as personal armor, is weight. Relatively heavy armor can reduce movement and carrying capacity. Conventional armor may include a vast majority of steel (having a density of about 8.05 g/cm³), TiO₂ (having a density of about 3.78 about 8.05 g/cm³), or SiC (having a density of about 3.3 g/cm³). Therefore, the density of the ceramic component 101 may be chosen to be less than the density of steel, TiO₂, or even SiC. For example, the density of the ceramic component 101 may be not greater than about 8.05 g/cm³. such as not greater than about 5.0 g/cm³, not greater than about 4.0 g/cm³, not greater than about 3.7 g/cm³, not greater than about 3.3 g/cm³, not greater than about 3.2 g/cm³, not greater than about 3.0 g/cm³, not greater than about 2.88 g/cm³, not greater than about 2.7 g/cm³, not greater than about 2.6 g/cm³, not greater than about 2.5 g/cm³, not greater than about 2.4 g/cm³, not greater than about 2.3 g/cm³, not greater than about 2.2 g/cm³, or even not greater than about 2.1 g/cm³. Still, in one non-limiting embodiment the ceramic component 101 can have a density that is at least about 0.1 g/cm³, such as at least about 0.5 g/cm³, at least about 1.0 g/cm³, at least about 1.5 g/cm³, at least about 1.6 g/cm³, at least about 1.7 g/cm³, at least about 1.8 g/cm³, at least about 1.9 g/cm³, or even at least about 2.0 g/cm³. It will be appreciated that the density of the ceramic component 101 can be within a range between any of the above minimum and maximum values. In a particular embodiment, the ceramic component 101 can have a density of at least 0.1 g/cm³ and not greater than 3.2 g/cm³.

In another embodiment, the ceramic component 101 can have a particular hardness, including, for example, a Mohs hardness of not greater than about 8. In other embodiments, the Mohs hardness of the ceramic component 101 may be less than about 8, such as not greater than about 7.5, not greater than about 7, not greater than about 6.5, not greater than about 6, not greater than about 5.5, not greater than about 5, not greater than about 4.5, not greater than about 4, not greater than about 3.5, not greater than about 3, not greater than about 2.5, not greater than about 2.2, not greater than about 2.0, not greater than about 1.9, not greater than about 1.7, not greater than about 1.5, not greater than about 1.2, or even not greater than about 1.0. Still, in a non-limiting embodiment, the ceramic component 101 may have a Mohs hardness of at least about 0.2, at least about 0.3, at least about 0.5, at least about 0.7, at least about 0.9, such at least about 1.0, such as least about 1.2, at least about 1.5, at least about 1.7, at least about 1.9, at least about 2.0, or even at least about 2.1. It will be appreciated that the ceramic component 101 can have a Mohs hardness within a range between any of the minimum and maximum values noted above.

In accordance with another embodiment, the ceramic component 101 can have a particular bulk modulus suitable for use in an armor component. For example, the ceramic component 101 can have a bulk modulus of not greater than about 350 GPa. In other embodiments, the bulk modulus of the ceramic component 101 may be less, such as not greater than about 300 GPa, not greater than about 250 GPa, not greater than about 200 GPa, not greater than about 150 GPa, not greater than about 100 GPa, or even not greater than about 80 GPa. Still, in another non-limiting embodiment, the ceramic component 101 can have a bulk modulus of at least 1 GPa, such as at least about 10 GPa, such as at least about 15 GPa, at least about 20 GPa, or even at least about 30 GPa. It will be appreciated that the ceramic component 101 can have a bulk modulus within a range between any of the minimum and maximum values noted above.

In accordance with another embodiment, the ceramic component 101 can have a particular hardness suitable for use as a portion of the armor component 100. For example, the ceramic component 101 can have a Vickers hardness measured at 1 kg load of not greater than about 26 GPa. In another embodiment, the Vickers hardness can be less, such as not greater than about 20 GPa, not greater than about 15 GPa, not greater than about 10 GPa, not greater than about 5 GPa, not greater than about 4 GPa, not greater than about 3 GPa, not greater than about 2 GPa, not greater than about 1 GPa, or even not greater than about 0.5 GPa. Still, it will be appreciated that in at least one embodiment, the ceramic component 101 may have a Vickers hardness of at least about 0.05 GPa, such as at least about 0.1 GPa, at least about 0.15 GPa, at least about 0.20 GPa, at least about 0.24 GPa, or eve at least about 0.25 GPa. It will be appreciated that the ceramic component 101 can have a Vickers hardness within a range between any of the minimum and maximum hardness values noted above.

In accordance with another embodiment, the ceramic component 101 can have a particular Young's modulus suitable for use as a portion of the armor component 100. For example, the ceramic component 101 can have a Young's modulus of not greater than about 340 GPa. In other embodiments, the ceramic component 101 can have a Young's modulus of not greater than about 300 GPa, such as not greater than about 250 GPa, not greater than about 200 GPa, not greater than about 150 GPa, not greater than about 100 GPa, not greater than about 50 GPa, or even not greater than about 25 GPa. Still, in at least one non-limiting embodiment, the ceramic component 101 can have a Young's modulus of at least about 15 GPa, such as at least about 20 GPa, at least about 30 GPa, at least about 40 GPa, at least about 50 GPa, at least about 60 GPa, at least about 70 GPa, at least about 80 GPa, at least about 90 GPa, at least about 100 GPa, or even at least about 103 GPa. It will be appreciated that the ceramic component 101 can have a Young's modulus within a range between any of the above minimum and maximum values.

In accordance with an embodiment, the ceramic component 101 may include a solid material, and more particularly, a solid ceramic material including grains. The grains may represent individual, single crystallites or domains within the body that can have an average grain size or median grain size (D₅₀) of a particular value making the ceramic component 101 suitable for use in embodiments described herein. For example, the ceramic component 101 can have grains having an average grain size of not greater than about 500 microns. In other embodiments, the average grain size of the ceramic component 101 can be less than about 400 microns, such as not greater than about 300 microns, not greater than about 200 microns, not greater than about 150 microns, not greater than about 100 microns, not greater than about 80 microns, not greater than about 70 microns, not greater than about 60 microns, not greater than about 50 microns, not greater than about 40 microns, not greater than about 30 microns, not greater than about 20 microns, not greater than about 10 microns, or even not greater than about 6 microns. Still, in other non-limiting embodiments, the ceramic component 101 may include grains having an average grain size of at least about 1 nanometer, such as at least about 0.01 microns, at least about 0.1 microns, at least about 1 micron, at least about 3 microns, at least about 5 microns, at least about 10 microns, at least about 20 microns, at least about 30 microns, at least about 40 microns, at least about 50 microns, at least about 60 microns, at least about 70 microns, at least about 80 microns, at least about 90 microns, at least about 100 microns, or even at least about 200 microns. It will be appreciated that the average grain size of the ceramic component 101 can be within a range between any of the minimum and maximum values noted above. For example, in a particular embodiment, the average grain size of the ceramic component 101 can be within a range of from about 3 microns to about 6 microns. In another particular embodiment, the average grain size of the ceramic component 101 can be within a range of from about 7 microns to about 10 microns.

Additionally, the ceramic component 101 can include grains defining a particular grain size distribution. For example, the grains of the ceramic component 101 can define a generally normal or Gaussian distribution of grain sizes. In other embodiments, the distribution of grain sizes within the ceramic component 101 can be defined by a multimodal grain size distribution. For example, in one particular instance, the ceramic component 101 can include grains defining a bimodal grain size distribution, including grains having a fine grain size and a second portion of grains having a course grain size, wherein the course grain size defines a distinct mode of grains having a larger average grain size than the average grain size of the grains having a finer grain size.

In accordance with another embodiment, the ceramic component 101 can include grains, which when viewed using suitable techniques including, for example, scanning electron microscopy, the grains may have a particular shape. For example, some suitable shapes of at least one of the grains can include a shape of elongated, equiaxed, platelet, irregular, and any combination thereof. In one particular embodiment, the ceramic component 101 can include grains having a platelet shape, which may be indicative of hexagonal boron nitride material having a generally platelet-shaped structure. It will be appreciated that at least a portion of all of the grains can have substantially the same shape.

In certain embodiments, the ceramic component 101 may include an additive material. The additive material may be present in an amount sufficient to facilitate formation of the ceramic component, and particularly in an amount greater than an impurity content. For example, the ceramic component can include an additive, which may be present in an amount of at least about 1 wt %, such as at least about 2 wt %, at least about 5 wt %, or even at least about 10 wt % of the total weight of the body of the ceramic component 101. However, in certain non-limiting embodiments, the additive may be present in a minority amount, such that it is not greater than about 50 wt % of the total weight of the body of the ceramic component 101.

Moreover, the ceramic component may include an additive, which may be preferentially disposed at certain regions of the microstructure of the ceramic component 101. For example, the additive may be substantially uniformly dispersed throughout the volume of the body of the ceramic component 101. In another instance, the additive may be disposed at the grain boundaries, such that the additive is an intergranular phase disposed between individual grains or domains throughout the body of the ceramic component 101. In another embodiment, the additive may be in the form of a layer, such as, for example, an additive layer overlying the ceramic component 101, the first component 102, or the second component 103.

In accordance with one particular instance, the additive can include an inorganic or organic material. More particularly, the additive may include an inorganic material, such as a ceramic, and more particularly an oxide. In certain instances, the additive may include silica, and more particularly fumed silica.

In accordance with one aspect, the ceramic component 101 may be formed such that it is in a ready state and configured to undergo a phase change upon projectile impact. More particularly, the ceramic component may be formed such that it is in a ready state defining a first lattice structure and configured to change from the ready state to an absorbed state defining a second lattice structure that is different from the first lattice structure, upon sufficient impact from a projectile. In accordance with an embodiment, the first lattice structure can be a hexagonal lattice structure. More particularly, in another embodiment, the absorbed state that defines the second lattice structure can include a cubic lattice structure. It will be appreciated that reference herein to a change in the ceramic component from a ready state to an absorbed state can include a change of only a portion of the ceramic component, such that after impact with a projectile, a portion of the ceramic component may still be in the ready state defining a first lattice structure while a second portion of the ceramic component may be in an absorbed state defined by the second lattice structure.

In accordance with an embodiment, the ceramic component can be in a ready state and defined by a transformation pressure defined as an applied pressure configured to cause a change in at least a portion of the ceramic component 101 from the ready state to the absorbed state. In particular instances, the transformation pressure to change a portion of the ceramic component from the ready state to the absorbed state may be not greater than about 1500 GPa, such as not greater than 1000 GPa, or even not greater than 500 GPa. In other instances, the transformation pressure may be less, such as not greater than about 400 GPa, not greater than about 300 GPa, not greater than about 200 GPa, not greater than about 100 GPa, not greater than about 5 GPa. In other instances, the transformation pressure may be less, such as not greater than about 30 GPa, not greater than 23 GPa, not greater than 18 GPa, not greater than about 15 GPa, not greater than about 14 GPa, not greater than about 13 GPa, not greater than about 12 GPa, not greater than about 11 GPa, not greater than about 10 GPa, not greater than about 9 GPa. Still, in one non-limiting embodiment, the transformation pressure can be at least about 0.01 MPa, such as at least about 0.05 MPa, at least about 0.1 MPa, at least about 0.5 MPa, at least about 0.01 GPa, at least about 0.05 GPa, at least about 0.1 GPa, at least about 0.5 GPa, at least about 1 GPa, at least about 2.5 GPa, at least about 4 GPa, or even at least about 5 GPa. It will be appreciated that the transformation pressure can be within a range of any of the minimum and the maximum values noted above, such as within a range of 5 GPa and 30 GPa, or even with a range of 10 GPa and 23 GPa.

In another aspect, the ceramic component 101 can include a transformation temperature defined as a change in temperature configured to cause the transformation of at least a portion of the ceramic component 101 from the ready state to the absorbed state. In accordance with an embodiment, the transformation temperature necessary to facilitate the change from the ready state to the absorbed state may be not greater than about 10000° C., such as not greater than about 5000° C. The transformation temperature may be at least about 1500° C., such as at least about 2000° C., or even at least about 2500° C. It will be appreciated that the transformation temperature of the ceramic component 101 can be within a range between any of the above minimum and maximum values noted above.

In another aspect the ceramic component 101 can include a transformation energy defined as a force configured to cause at least a portion of the material component to change from the ready state to the absorbed state, wherein the transformation energy is at least 2500 J, at least 3000 J, at least 3500 J, at least 4000 J. In a non-limiting embodiment, the transformation force may be no greater than 10,000 J or even no greater than 4000 J. In a further aspect, the transformation force can be at least 0.50×10⁶ N and yet no greater than 1.50×10⁶ N. In a particular embodiment, the transformation force can be in a range within any of the maximum or minimum values indicated above, such as within a range of at least 0.56×10⁶ N and not greater than 1.26×10⁶ N.

In accordance with another aspect, the ceramic component 101 can be formed such that it is defined by a ready state having a first density (ρᵣ) and configured to change at least a portion of the ceramic component 101 from the ready state to an absorbed state, wherein the absorbed state is defined by a second density (ρₐ). Notably, the density of the ceramic component 101 in the ready state (i.e., the first density, ρᵣ) can be less than the density of the material in the absorbed state (i.e., the second density, ρₐ), as measured by the equation [(ρₐ−ρᵣ)/ρₐ]×100%. It will be appreciated that the percent difference in density can be measured as the absolute value of the equation noted herein.

For example, in accordance with particular instances, the first density (ρᵣ) defining a ready state of the ceramic component 101 can be at least about 0.1% less than the second density (ρₐ) defining an absorbed state of the ceramic component 101, such as, for example, at least about 0.5% ess, at least about 1% less, at least about 2% less, at least about 3% less, at least about 4% less, at least about 5% less, at least about 6% less, at least about 7% less, at least about 8% less, at least about 9% less, at least about 10% less, at least about 12% less, at least about 15% less, at least about 20% less, at least about 25% less, at least about 30% less, at least about 35% less, at least about 40% less, at least about 45% less, at least about 50% less, at least about 55% less, at least about 60% less, at least about 65% less, at least about 70% less, at least about 75% less, at least about 80% less, at least about 85% less, at least about 90% less, at least about 95% less, at least about 98% less, or even at least about 99% less. In accordance with other particular instances, the first density may be greater than the second density by not greater than about 0.1%, such as not greater than about 0.5%, not greater than about 1%, not greater than about 2%, not greater than about 3%, not greater than about 4%, not greater than about 5%, not greater than about 6%, not greater than about 7%, not greater than about 8%, not greater than about 9%, not greater than about 10%, not greater than about 12%, not greater than about 15%, not greater than about 20%, not greater than about 25%, not greater than about 30%, not greater than about 35%, not greater than about 40%, not greater than about 45%, not greater than about 50%, not greater than about 55%, not greater than about 60%, not greater than about 65%, not greater than about 70%, not greater than about 75%, not greater than about 80%, not greater than about 85%, not greater than about 90%, not greater than about 95%, not greater than about 98%, or even not greater than about 99%. It will be appreciated that the difference in density can be within a range between any of the minimum and maximum values noted above.

As illustrated in FIG. 1, the ceramic component 101 can have a particular thickness (t_{cc}). In accordance with an embodiment, the ceramic component 101 can have a thickness of at least about 4 mm. In other embodiments, the thickness of the ceramic component can be greater, such as at least about 8 mm, at least about 10 mm, at least about 11 mm, at least about 12 mm, at least about 13 mm, at least about 14 mm, at least about 15 mm, at least 20 mm, at least 50 mm, or even at least 75 mm. Still, in a non-limiting embodiment, the ceramic component may have a thickness that is not greater than about 100 mm, such as not greater than about 75 mm, not greater than about 50 mm, not greater than about 20 mm, such as not greater than about 19 mm, not greater than about 18 mm, not greater than about 17 mm, not greater than about 16 mm, or even not greater than about 15 mm. It will be appreciated that the thickness of the ceramic component 101 can be within a range between any of the minimum and maximum vales noted above. For example, in certain instances, such as with personal body armor, the thickness of the ceramic component 101 can be within a range of 8 mm to 20 mm, or even within a range of 8 mm to 15 mm. In other instances, such as with vehicle armor, the thickness of the ceramic component 101 can be within a range of 50 mm to 100 mm.

As further noted in FIG. 1, the armor component 100 can include a first component 102 that may be adjacent to the ceramic component 101. In accordance with an embodiment, the first component 102 can be abutting at least a portion of the ceramic component 101, and more particularly, may be in direct contact with a first major surface 105 of the ceramic component 101. More particularly, the first component 102 and ceramic component 101 may be bonded to each other at the first major surface 105 of the ceramic component 101.

In an embodiment, the first component 102 can have a particular thickness (t_{fc}). For example, the first component 102 can have a thickness of at least about 1 mm. In other embodiments, the thickness of the ceramic component can be greater, such as at least about 2 mm, at least about 4 mm, at least about 8 mm, or at least about 10 mm. In a non-limiting embodiment, the first component 102 may have a thickness that is not greater than about 30 mm, such as not greater than 20 mm, or even not greater than 12 mm. It will be appreciated that the thickness of the first component 102 can be within a range between any of the minimum and maximum vales noted above. For example, the thickness of the first component 102 can be within a range of 2 mm to 8 mm. In a particular instance, the first component 102 can have a thickness that is about 6.4 mm, which corresponds to ¼″. In another instance, the first component 102 can have a thickness that is about 2 mm.

In accordance with an embodiment, the first component may include a particular material, including but not limited to a ceramic, such as a boride, a nitride, an oxide, a carbide, and any combination thereof. In particular, the first component 102 may include alumina (Al₂O₃), boron carbide (B₄C), silicon carbide (SiC), calcium hexaboride (CaB₆), aluminum dodecaboride (AlB₁₂), boron suboxide (B₆O), silicon nitride (Si₃N₄), aluminum nitride (AlN), and any combination thereof. In still another alternative embodiment, the first component 102 may include a material, such as an organic material component, and more particularly a polymer, such as a polyethylene, polyurethane, a fluorinated polymer, a resin, a thermoset, a thermoplastic, a para-aramid fiber, and any combination thereof.

Further, it will be appreciated that the first component 102 may include a composite material, which may include a combination of materials, including for example natural materials, synthetic materials, organic materials, inorganic materials, and any combination thereof. Some suitable inorganic materials can include ceramics, metals, glasses, and the like.

In one particular embodiment, the first component 102 may include a boride material. In particular instances, the boride material may include one metal element, including, for example, but not limited to, a transition metal element. In certain instances, the metal element may include zirconium (Zr), titanium (Ti), aluminum (Al), and a combination thereof. For example, the first component 102 may include calcium hexaboride (CaB₆), aluminum dodecaboride (AlB₁₂), magnesium aluminum diboride (MgAlB₂). In one particular instance, the first component 102 may include zirconium boride (ZrB₂). In still another embodiment, the first component 102 may include titanium boride (TiB₂).

In an alternative embodiment, the first component 102 may include a composition, such as a first composition that is different than the composition of the ceramic component 101. For example, the first component 102 may include a first composition including a nitride material that is different than a nitride material contained within the ceramic component 101. The nitride material of the first component 102 may include a metal element, in particular a transition metal element. In particular instances, the first component 102 may include silica nitride (Si₃N₄), titanium nitride (TiN), aluminium nitride (AlN), and a combination thereof.

In accordance with another embodiment, the first component 102 may include a ceramic material, including an oxide material. In certain instances, the oxide material may include aluminum oxide (Al₂O₃), boron suboxide (B₆O), and a combination thereof. In other instances, the oxide material may include at least one element, including, but not limited to, a transition metal element. For example, some suitable metal elements can include yttrium (Y), lanthanum (La), and a combination thereof. In one particular instance, the first component 102 can include an oxide material including yttria (Y₂O₃). In another embodiment, the first component 102 can include an oxide material comprising lanthanum oxide (La₂O₃).

In still another embodiment, the first component may include a ceramic material, such as a carbide material. Suitable carbide materials may include at least one metal element, including, for example, but not limited to, a transition metal element. Some suitable transitional metal elements can include, for example, titanium (Ti), aluminum (Al), boron (B), and a combination thereof. For example, the first component 102 may include a ceramic material comprising titanium carbide (TiC). In another embodiment, the first component 102 can include a carbide material including aluminum carbide (Al₄C₃). In another embodiment, the first component 102 may include silicon carbide (SiC). In yet another embodiment, the first component may include a carbide material including boron carbide (B₄C).

In still other instances, the first component 102 may include some natural materials, for example a woven material. In other instances, the first component 102 may include a non-woven material. Some suitable examples of woven and non-woven material can include those utilizing a fiber, and more particularly, may include a ballistic fiber. In accordance with an embodiment, the ballistic fiber may include a natural material, synthetic material, and a combination thereof. According to one particular design, the first component 102 may include a ballistic fiber that includes nylon.

In accordance with an embodiment, the ceramic component 101 can have a particular thickness (t_{cc}) and the first component 102 may have a particular thickness (t_{fc}). In certain instances, the first component 102 can have a thickness (t_{fc}) that is substantially the same as the thickness (t_{cc}) as the ceramic component 101. And yet in another design, the thickness of the ceramic component 101 can be significantly different than the thickness of the first component 102. For example, in one embodiment, the ceramic component 101 can have a thickness that is greater than the first component 102. Still, it will be appreciated that the ceramic component 101 can have a thickness that is less than the thickness of the first component 102.

In particular embodiments, the ceramic component 101 can have a thickness that is at least about 1% less than the thickness of the first component 102 as measured by the equation [(t_{cc}−t_{fc})/t_{cc}]×100%. It will be appreciated that the difference of thickness can be measured as the absolute value of the equation noted herein. In accordance with another embodiment, the ceramic component 101 can have a thickness that is at least about 2% less than the thickness of the first component 102, that is, at least about 3% less, at least about 4% less, at least about 5% less, at least about 6% less, at least about 7% less, at least about 8% less, at least about 9% less, at least about 10% less, at least about 12% less, at least about 15% less, at least about 20% less, at least about 25% less, at least about 30% less, at least about 35% less, at least about 40% less, at least about 45% less, at least about 50% less, at least about 55% less, at least about 60% less, at least about 65% less, at least about 70% less, at least about 75% less, at least about 80% less, at least about 85% less, at least about 90% less, at least about 95% less, at least about 98% less, or even at least about 99% less. In accordance with an embodiment, the ceramic component 101 can have a thickness that is greater than the thickness of the first component 102 by not greater than about 1%, such as not greater than about 2%, not greater than about 3%, not greater than about 4%, not greater than about 5%, not greater than about 6%, not greater than about 7%, not greater than about 8%, not greater than about 9%, not greater than about 10%, not greater than about 12%, not greater than about 15%, not greater than about 20%, not greater than about 25%, not greater than about 30%, not greater than about 35%, not greater than about 40%, not greater than about 45%, not greater than about 50%, not greater than about 55%, not greater than about 60%, not greater than about 65%, not greater than about 70%, not greater than about 75%, not greater than about 80%, not greater than about 85%, not greater than about 90%, not greater than about 95%, not greater than about 98%, or even not greater than about 99%. It will be appreciated that the percent difference in thickness between the ceramic component 101 and first component 102 can be within a range between any of the minimum and maximum percentages noted above.

In particular embodiments, the first component 102 can have a thickness that is at least about 1% less than the thickness of the ceramic component 101 as measured by the equation [(t_{fc}−t_{cc})/t_{fc}]×100%. It will be appreciated that the difference of thickness can be measured as the absolute value of the equation noted herein. In accordance with another embodiment, the first component 102 can have a thickness that is at least about 1% less than the thickness of the ceramic component 101, that is, at least about 2%, that is, at least about 3% less, at least about 4% less, at least about 5% less, at least about 6% less, at least about 7% less, at least about 8% less, at least about 9% less, at least about 10% less, at least about 12% less, at least about 15% less, at least about 20% less, at least about 25% less, at least about 30% less, at least about 35% less, at least about 40% less, at least about 45% less, at least about 50% less, at least about 55% less, at least about 60% less, at least about 65% less, at least about 70% less, at least about 75% less, at least about 80% less, at least about 85% less, at least about 90% less, at least about 95% less, at least about 98% less, or even at least about 99% less. In accordance with an embodiment, the first component 102 can have a thickness that may be greater than the thickness of the ceramic component 101 by not greater than about 1%, such as not greater than about 2%, not greater than about 3%, not greater than about 4%, not greater than about 5%, not greater than about 6%, not greater than about 7%, not greater than about 8%, not greater than about 9%, not greater than about 10%, not greater than about 12%, not greater than about 15%, not greater than about 20%, not greater than about 25%, not greater than about 30%, not greater than about 35%, not greater than about 40%, not greater than about 45%, not greater than about 50%, not greater than about 55%, not greater than about 60%, not greater than about 65%, not greater than about 70%, not greater than about 75%, not greater than about 80%, not greater than about 85%, not greater than about 90%, not greater than about 95%, not greater than about 98%, or even not greater than about 99%. It will be appreciated that the percent difference in thickness between the first component 102 and ceramic component 101 can be within a range between any of the minimum and maximum percentages noted above.

In an embodiment, the thickness of the ceramic component 101 (t_{cc}) can be configured to prevent penetration of a projectile having a particular energy upon impact of the projectile with the strikeface 106 of the ceramic component 101. For instance, a exemplary projectile having an average weight of about 14 g and a velocity of about 800 m/s (2625 ft/s) can provide a kinetic energy of about 4000 J. In an embodiment, the thickness of the ceramic component 101 (t_{cc}) can be configured to prevent penetration of a projectile having an energy of at least 2500 J, such as at least 3000 J, at least 3500 J, or at least 4000 J, upon impact with the strikeface 106. In an embodiment, such as an embodiment employed with vehicle armor, the thickness of the ceramic component 101 (t_{cc}) can be configured to be no greater than 100 mm. In another embodiment, such as an embodiment employed with personal armor, the thickness of the ceramic component 101 (t_{cc}) can be configured to be no greater than 30 mm, such as no greater than 27 mm, no greater than 24 mm, or no greater than 21 mm.

In an embodiment, the ceramic component 101 may have a ceramic component density (d_{cc}) and the first component 102 may have a first component density (d_{fc}). In particular instances, the first component density can be substantially the same as the ceramic component density. In other instances, the ceramic component density can be significantly less than the first component density. For example, the ceramic component density may be greater than the first component density. However, in other non-limiting embodiments, the ceramic component density may be less than the first component density. In accordance with an embodiment, the ceramic component density can be at least 1% less than the first component density as defined by the absolute value of the equation [(d_{cc}−d_{fc})/d_{cc})]×100%. It will be appreciated that the difference of density can be measured as the absolute value of the equation noted herein. In accordance with another embodiment, the ceramic component can have a density that is at least about 2% less than the first component density, that is, at least about 3% less, at least about 4% less, at least about 5% less, at least about 6% less, at least about 7% less, at least about 8% less, at least about 9% less, at least about 10% less, at least about 12% less, at least about 15% less, at least about 20% less, at least about 25% less, at least about 30% less, at least about 35% less, at least about 40% less, at least about 45% less, at least about 50% less, at least about 55% less, at least about 60% less, at least about 65% less, at least about 70% less, at least about 75% less, at least about 80% less, at least about 85% less, at least about 90% less, at least about 95% less, at least about 98% less, or even at least about 99% less. In accordance with an embodiment, the ceramic component density can be greater than the first component density by not greater than about 1%, such as not greater than about 2%, not greater than about 3%, not greater than about 4%, not greater than about 5%, not greater than about 6%, not greater than about 7%, not greater than about 8%, not greater than about 9%, not greater than about 10%, not greater than about 12%, not greater than about 15%, not greater than about 20%, not greater than about 25%, not greater than about 30%, not greater than about 35%, not greater than about 40%, not greater than about 45%, not greater than about 50%, not greater than about 55%, not greater than about 60%, not greater than about 65%, not greater than about 70%, not greater than about 75%, not greater than about 80%, not greater than about 85%, not greater than about 90%, not greater than about 95%, not greater than about 98%, or even not greater than about 99%. It will be appreciated that the difference between the density of the ceramic component 101 and the density of the first component 102 can be within a range between any of the minimum and the maximum percentages noted above.

In accordance with an embodiment, the armor component can be configured to have a particular areal density defined as the sum of the products of the ceramic component density (d_{cc}) multiplied by the ceramic component thickness (t_{cc}), and the first component density (d_{fc}) multiplied by the first component thickness (t_{fc}), or as calculated by the formula [(d_{cc})*(t_{cc})]+[(d_{fc})*(t_{fc})]. In a particular instance, the armor component can have an areal density of no greater than 1 kg/cm², no greater than 500 g/cm², no greater than 340 g/cm², such as no greater than 300 g/cm², no greater than 270 g/cm², or no greater than 240 g/cm². In a non-limiting embodiment, the armor component can have an areal density that is at least 1.1 g/cm².

In yet another aspect, the ceramic component 101 can have a ceramic component hardness (h_{cc}) and the first component 102 may have a first component hardness (h_{fc}). In particular instances, the first component hardness may be substantially the same as the ceramic component hardness. Still, in other designs, the ceramic component hardness can be substantially different that the first component hardness. For example, in certain instances, the ceramic component hardness can be greater than the first component hardness.

Still, in another non-limiting embodiment, the ceramic component hardness can be less than the first component hardness. In particular embodiments, the ceramic component hardness can be less from the first component hardness by at least about 1% difference as defined by the absolute value of the equation [(h_{cc}−h_{fc})/h_{cc}]×100%, such as, for example, at least about 2%, at least about 3%, at least about 4%, at least about 5%, at least about 6%, at least about 7%, at least about 8%, at least about 9%, at least about 10%, at least about 12%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 90%, at least about 95%, at least about 98%, or even at least about 99%. In other non-limiting embodiments, the ceramic component hardness can be greater than the first component hardness by not greater than about 1%, such as not greater than about 2%, not greater than about 3%, not greater than about 4%, not greater than about 5%, not greater than about 6%, not greater than about 7%, not greater than about 8%, not greater than about 9%, not greater than about 10%, not greater than about 12%, not greater than about 15%, not greater than about 20%, not greater than about 25%, not greater than about 30%, not greater than about 35%, not greater than about 40%, not greater than about 45%, not greater than about 50%, not greater than about 55%, not greater than about 60%, not greater than about 65%, not greater than about 70%, not greater than about 75%, not greater than about 80%, not greater than about 85%, not greater than about 90%, not greater than about 95%, not greater than about 98%, or even not greater than about 99%. It will be appreciated that the difference in the ceramic component hardness relative to the first component hardness can be within a range between any of the minimum and maxiumum percentages noted above.

In another aspect, the armor component 100 may include a second component 103 that is distinct from the first component 102 and ceramic component 101. For example, referring to FIG. 3, the second component 103 is illustrated as a distinct component relative to first component 102 and ceramic component 101. In certain instances, such as illustrated in FIG. 3, the second component 103 may be in the form of a layer. As such, the second component 103 can have dimensions substantially similar to the ceramic component 101 and first component 102 as described in embodiments herein. As further illustrated, the second component 103 may be adjacent to the ceramic component 101. More particularly, the second component 103 may be overlying the ceramic component 101. For example, the second component 103 can be underlying the ceramic component, and more particularly, may be abutting the ceramic component 101.

It will be appreciated that the second component 103 can have any of the attributes of the first component 102 and the ceramic component 101 described in the embodiments herein.

In certain aspects, the ceramic component 101 may be a composite including a first material and a second material. In particular, the first material may define a first material phase and the second material may define a second material phase, wherein the first material phase and the second material phase are separate and discrete phases with respect to each other. For example, in at least one embodiment, the first material phase may define a solid phase material, and the second phase material may define a liquid phase material.

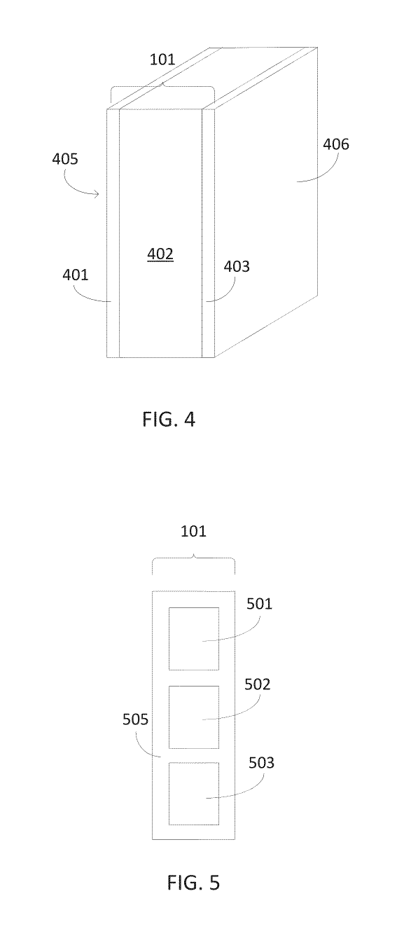

FIG. 4 includes an illustration of a portion of a ceramic component 101 as a composite in accordance with an embodiment. Notably, as illustrated, the ceramic component 101 can include a first portion 401 defining a first major surface 405 and a second portion 402 adjacent the first portion 401. Furthermore, the ceramic portion 101 can include a third portion 403 abutting the second portion 402 and defining a second major surface 406.

In accordance with an embodiment, the ceramic component 101 can include a first portion 401 defining a first material and second portion 402 defining a second material distinct from the first material. As illustrated in FIG. 4, the first portion 401 and the second portion 402 can define distinct portions of the entire volume of the body of the ceramic component 101. Notably, in the embodiment in FIG. 4, the first portion 401 can extend to define a first major surface 405 while the second portion 402 is disposed between the first portion 401 and the third portion 403.

It will be appreciated that various combinations of portions may be utilized to form a composite ceramic component 101. In particular instances, the first portion 401 and second portion 402 can define volumes of the entire volume of the body of the composite ceramic component 101. For example, as illustrated in FIG. 4, the second portion 402 can define a majority of the volume of the body of the composite ceramic component 101 as compared to the first portion 401 and third portion 403. However, it will be appreciated that in other embodiments, the first portion 401 may define a majority of the volume of the entire volume of the body of the composite ceramic component 101. In particular instances, it will be appreciated that the first volume defined by the first portion 401 and the second volume defined by the second portion 402 can be substantially the same.

However, in other instances, the first volume defined by the first portion 401 may be different from the second volume defined by the second portion 402. More particularly, the first volume of the first portion 401 may be less than the second volume of the second portion 402 based upon the equation [(λ₁−λ₂)]×100%, where λ₁ represents the volume of the first portion 401 relative to the entire volume of the composite ceramic component 101, and λ₂ represents the volume of the second portion 402 relative to the entire volume of the composite ceramic component 101. It will be appreciated that the percent difference in volume can be measured as the absolute value of the equation noted herein. In accordance with an embodiment, the first volume defined by the first portion 401 may be at least about 1% less than the second volume defined by the second portion 402. In accordance with another embodiment, the first volume P1 can be at least about 2% less than the second volume P2, that is, at least about 3% less, at least about 4% less, at least about 5% less, at least about 6% less, at least about 7% less, at least about 8% less, at least about 9% less, at least about 10% less, at least about 12% less, at least about 15% less, at least about 20% less, at least about 25% less, at least about 30% less, at least about 35% less, at least about 40% less, at least about 45% less, at least about 50% less, at least about 55% less, at least about 60% less, at least about 65% less, at least about 70% less, at least about 75% less, at least about 80% less, at least about 85% less, at least about 90% less, at least about 95% less, at least about 98% less, or even at least about 99% less. In other non-limiting embodiments, the first volume can be greater than the second volume by not greater than about 1%, such as not greater than about 2%, not greater than about 3%, not greater than about 4%, not greater than about 5%, not greater than about 6%, not greater than about 7%, not greater than about 8%, not greater than about 9%, not greater than about 10%, not greater than about 12%, not greater than about 15%, not greater than about 20%, not greater than about 25%, not greater than about 30%, not greater than about 35%, not greater than about 40%, not greater than about 45%, not greater than about 50%, not greater than about 55%, not greater than about 60%, not greater than about 65%, not greater than about 70%, not greater than about 75%, not greater than about 80%, not greater than about 85%, not greater than about 90%, not greater than about 95%, not greater than about 98%, or even not greater than about 99%. It will be appreciated that the percent difference in the first volume relative to the second volume can be within a range between any of the minimum and maxiumum percentages noted above.

However, in still other instances, the second volume defined by the second portion 402 may be less than the first volume of the first portion 401 based upon the equation [(P2−P1)/P2]×100%, where P1 represents the first portion and P2 represents the second portion. Similar to above, it will be appreciated that the percent difference in volume can be measured as the absolute value of the equation noted herein. In accordance with an another embodiment, the second volume defined by the second portion 402 may be at least about 1% less than the first volume defined by the first portion 401. In accordance with particular instances, the second volume P2 can be at least about 2% less than the first volume P1, that is, at least about 3% less, at least about 4% less, at least about 5% less, at least about 6% less, at least about 7% less, at least about 8% less, at least about 9% less, at least about 10% less, at least about 12% less, at least about 15% less, at least about 20% less, at least about 25% less, at least about 30% less, at least about 35% less, at least about 40% less, at least about 45% less, at least about 50% less, at least about 55% less, at least about 60% less, at least about 65% less, at least about 70% less, at least about 75% less, at least about 80% less, at least about 85% less, at least about 90% less, at least about 95% less, at least about 98% less, or even at least about 99% less. In other non-limiting embodiments, the second volume can be greater than the first volume by not greater than about 1%, such as not greater than about 2%, not greater than about 3%, not greater than about 4%, not greater than about 5%, not greater than about 6%, not greater than about 7%, not greater than about 8%, not greater than about 9%, not greater than about 10%, not greater than about 12%, not greater than about 15%, not greater than about 20%, not greater than about 25%, not greater than about 30%, not greater than about 35%, not greater than about 40%, not greater than about 45%, not greater than about 50%, not greater than about 55%, not greater than about 60%, not greater than about 65%, not greater than about 70%, not greater than about 75%, not greater than about 80%, not greater than about 85%, not greater than about 90%, not greater than about 95%, not greater than about 98%, or even not greater than about 99%. It will be appreciated that the difference in the second volume relative to the first volume can be within a range between any of the minimum and maxiumum percentages noted above.

FIG. 5 includes a cross-sectional illustration of a portion of a composite ceramic component in accordance with an embodiment. As illustrated, the composite ceramic component 101 can include portions 501, 502, and 503, which are spaced apart from each other by a portion 505. In particular instances, the portions 501, 502, and 503 may define a first portion of the composite ceramic component 101, while the portion 505 can define a second portion distinct in material, composition, or mechanical characteristic from the first portion. In particular instances, the first portion and the second portion can be arranged in a predetermined distribution relative to each other. For example, the first portion can define an ordered distribution within the second portion. Moreover, while not illustrated, it will be appreciated that in other embodiments, the second portion can define an ordered distribution within the first portion.

Furthermore, while not illustrated herein, it will be appreciated that various arrangements of components may be utilized to form a composite ceramic component. As noted herein, the composite ceramic components may utilize first portions and second portions that are distinct from each other. It will be appreciated that it is contemplated that a composite ceramic component of any of the embodiments herein may include a first component defining a first layer and a second component defining a second layer that may be in contact with each other, either directly or indirectly. In other embodiments, the first and second components may be overlying each other, underlying each other, or abutting each other. Moreover, it will be appreciated that the first component and the second component may be in the form of elongated members that may be interwoven with each other. In still another embodiment, the first portion may define a particular two-dimensional shape, including for example a polygon, ellipsoid, circle, Roman numeral, Roman alphabet character, Kanji character, and a combination thereof. In fact, the first portion may define any identifiable indicia, and further, may be disposed within the second portion to facilitate formation of the indicia. Yet, in another embodiment, the second portion may have the same characateristics, such that it may define a two-dimensional shape, such as a polygon, ellipsoid, circle, Roman numeral, Roman alphabet character, Kanji character, and a combination thereof. In accordance with one aspect, the armor component of the embodiments herein may be utilized in various applications. For example, the armor component may be sewn in to an article of clothing. In other embodiments, the armor component may be utilized in a vehicle, a water-based vehicle, an aeronautical vehicle, a building, a shield, and any combination thereof.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the items as listed below.

Items

Item 1. An armor component comprising a body including a material component configured to undergo a phase change upon a projectile impact, wherein the material component has a density of not greater than 3.7 g/cm³.

Item 2. The armor component of item 1, wherein the material component has a density of not greater than 3.2 g/cm³, not greater than 3.0 g/cm³, not greater than 2.8 g/cm³, not greater than 2.6 g/cm³, not greater than 2.2 g/cm³, or not greater than 2.1 g/cm³.

Item 3. The armor component of item 1 or 2, wherein the material component has a strikeface.

Item 4. The armor component of any one of the above items, wherein the material component has a thickness no greater than 100 mm, and is configured to prevent pentration of a projectile having an energy of 2500 J to 10000 J upon impact with the strikeface of the material component.

Item 5. The armor component of item 4, wherein the material component has a thickness of no greater than 75 mm, or no greater than 50 mm.

Item 6. The armor component of item 4 or 5, wherein the material component has a thickness of no greater than 30 mm, no greater than 20 mm, or no greater than 14 mm.

Item 7. The armor component of any one of items 4 to 6, wherein the material component has a thickness of at least 4 mm.

Item 8. The armor component of any one of items 4 to 7, wherein the material component has a thickness in a range of 4 mm to 10 mm.

Item 9. The armor component of any one of items 4 to 8, wherein the armor component has an areal density of no greater than 1 kg/cm², no greater than 500 g/cm², no greater than 340 g/cm², no greater than 300 g/cm², no greater than 270 g/cm², or no greater than 240 g/cm².

Item 10. The armor component of item 9, wherein the areal density of at least 1.1 g/cm².

Item 11. The armor component of any one of the above items, wherein the material component includes a plurality of platelets stacked upon each other, the plurality of platelets include basal planes and at least 50% of the platelets within the plurality of platelets are oriented with their basal planes within 85° of parallel to the strikeface, within 60° of parallel to the strikeface, within 45° of parallel to the strikeface, within 30° of parallel to the strikeface, or within 20° of parallel to the strikeface.

Item 12. The armor component of item 11, wherein at least 70%, at least 90%, or at least 95% of the platelets within the plurality of platelets are oriented with their basal planes within 30° of parallel to the strikeface.

Item 13. The armor component of item 11, wherein the strikeface lies substantially along a single plane.

Item 14. The armor component of item 11, wherein the strikeface lies along a curve.

Item 15. The armor component of item 11, wherein the strikeface has a corresponding plane representative of the strikeface, and wherein at least 50% of the platelets within the plurality of platelets include basal planes oriented within 30° of parallel to the corresponding plane.

Item 16. The armor component of any one of the above items, wherein the material component has a ready state defining a first lattice structure and configured to change from the ready state to an absorbed state defining a second lattice structure different from the first lattice structure.

Item 17. The armor component of any one of the above items, wherein the material component has a ready state having a first density and configured to change from the ready state to an absorbed state having a second density, wherein the first density is less than the second density.

Item 18. The armor component of any one of items 3-17, wherein the strikeface comprises a polygonal two-dimensional shape.

Item 19. The armor component of any one of the above items, wherein the material component comprises a density of at least 2.0 g/cm³, at least 2.3 g/cm³, at least 2.6 g/cm³, at least 2.9 g/cm³, or at least 3.0 g/cm³.

Item 20. The armor component of any one of the above items, wherein the material component comprises a Mohs hardness of at least 0.2 and not greater than 8.

Item 21. The armor component of any one of the above items, wherein the material component comprises a Bulk Modulus of not greater than 350 GPa and at least 1 GPa.

Item 22. The armor component of any one of the above items, wherein the material component comprises a Vickers hardness measured at 1 kg load of not greater than 26 GPa and at least 0.05 GPa.

Item 23. The armor component of any one of the above items, wherein the material component comprises a Young's modulus of not greater than 340 GPa and at least 15 GPa.

Item 24. The armor component of any one of the above items, wherein material component comprises platelike grains having an average diameter of 7 microns to 10 microns, and an average thickness of 0.1 microns to 0.3 microns.

Item 25. The armor component of item 24, wherein the grains of the material component define a normal distribution of grain sizes, or wherein the grains of the material component define a bimodal grain size distribution.

Item 26. The armor component of any one of the above items, wherein the material component comprises an additive, and wherein the additive includes an inorganic material, more particularly a ceramic material, more particularly an oxide, silica, fumed silica, or a combination thereof.

Item 27. The armor component of any one of the above items, wherein the material component further comprises a transformation pressure defined as an applied pressure configured to cause at least a portion of the material component to change from a ready state to an absorbed state, wherein the transformation pressure is at least 2.5 GPa.

Item 28. The armor component of any one of the above items, wherein the material component further comprises a transformation temperature defined as a change in temperature configured to cause at least a portion of the material component to change from the ready state to the absorbed state, wherein the transformation temperature is not greater than 5000° C. and is at least 1500° C.

Item 29. The armor component of any one of the above items, wherein the material component further comprise a transformation force defined as a force configured to cause at least a portion of the material component to change from a ready state to an absorbed state, wherein the transformation force is at least 0.25×10⁶ N and not greater than 1.50×10⁶ N.

Item 30. The armor component of any one of the above items, wherein the material component further comprise a transformation energy defined as a force configured to cause at least a portion of the material component to change from a ready state to an absorbed state, wherein the transformation energy is at least 1500 J, at least 2500 J, at least 3000 J, at least 3500 J, at least 4000 J, and not greater than 10,000 J.

Item 31. The armor component of any one of the above items, wherein the material component comprises a thickness (t_{cc}) of at least 0.01 microns and not greater than 20 mm, not greater than 15 mm, not greater than 12 mm, not greater than 10 mm, not greater than 5 mm.

Item 32. The armor component of any one of the above items, wherein the material component comprises a majority content of a solid phase.

Item 33. The armor component of any one of the above items, wherein the material component comprises a composite including a first material and a second material, wherein the first material defines a first material phase and the second material defines a second material phase, and wherein the first material phase and the second material phase are separate phases with respect to each other.

Item 34. The armor component of any one of the above items, wherein the material component comprises a composite including a first material and a second material, wherein the first material defines a first portion of a body of the material component and the second material defines a second portion of the body of the material component, wherein the first portion and the second portion are separate portions of the body.

Item 35. The armor component of any one of the above items, wherein the material component comprises a first major surface, a second major surface, and a side surface extending between the first major surface and the second major surface, wherein the side surface defines a thickness of the body.

Item 36. The armor component of any one of the above items, wherein the armor component is part of an article of clothing, a vehicle, a water-based vehicle, an aero-based vehicle, a building, a shield, or a combination thereof.

Item 37. The armor component of any one of the above items, wherein the armor component is sewn into an article of clothing.

Item 38. The armor component of any one of items 1 to 3, 5 to 7, and 9 to 37, further comprising a first component disposed on or adjacent the material component.

Item 39. The armor component of item 38, wherein the material component comprises a material component thickness (t_{cc}) and the first component comprises a first component thickness (t_{fc}), wherein the material component thickness is less than the first component thickness, wherein the material component thickness is at least 1% less than the first component thickness and not greater than 99.9% less as defined by the equation [(t_{cc}−t_{fc})/t_{cc}]×100%.

Item 40. The armor component of item 38 or 39, wherein the material component comprises a material component density (d_{cc}) and the first component comprises a first component density (d_{fc}), wherein the material component density is less than the first component density, wherein the material component density is at least 1% less than the first component density and not greater than 99.9% less as defined by the equation [(d_{cc}−d_{fc})/d_{cc}]×100%.

Item 41. The armor component of any one of items 38 to 40, wherein the material component comprises a material component hardness (h_{cc}) and a first component comprises a first component hardness (h_{fc}), wherein the material component hardness is less than the first component hardness, wherein the material component hardness is at least 1% less than the first component hardness and not greater than 99.9% less as defined by the equation [(h_{cl}−h_{fl})/h_{cl}]×100%.

Item 42. The armor component of any one of items 38 to 41, wherein the first component includes an organic material, a ceramic material, a glass material, a metal material, a natural material, or a combination thereof.

Item 43. The armor component of any one of items 38 to 42, wherein the first component comprises a nitride, an oxide, a carbide, more particularly alumina, silicon carbide, boron carbide, olyethylene, polyurethane, a fluorinated polymer, a resin, a thermoset, a thermoplastic, or a combination thereof.

Item 44. The armor component of any one of items 38 to 43, wherein the first component comprises a boride material including at least one metal element, wherein the metal element comprises a transition metal element, more particularly wherein the metal element comprises Zr, Ti, and a combination thereof, even more particularly wherein the first component comprises ZrB₂, wherein the first component comprises TiB₂.

Item 45. The armor component of any one of items 38 to 44, wherein the first component comprises a first composition less than a composition of the material component, wherein the first component comprises a nitride material less than a nitride material of the composition of the material component, more particularly wherein the first component comprises a nitride material selected from the group consisting of Si₃N₄, TiN, AlN, CaB₆, AlB₁₂, and a combination thereof.

Item 46. The armor component of any one of items 38 to 45, wherein the first component comprises an oxide material including at least one metal element, wherein the metal element comprises a transition metal element, more particularly wherein the metal element comprises an element selected from the group consisting of Y, La, Al, B, and a combination thereof, more particularly wherein the first component comprises Y₂O₃, more particularly wherein the first component comprises La₂O₃, more particularly wherein the first component comprises Al₂O₃, more particularly wherein the first component comprises B₆O.

Item 47. The armor component of any one of items 38 to 46, wherein the first component comprises a carbide material including at least one metal element, wherein the metal element comprises a transition metal element, more particularly wherein the metal element comprises an element selected from the Ti, Al, B, Si, and a combination thereof, more particularly wherein the first component comprises TiC, more particularly wherein the first component comprises AlC, more particularly wherein the first component comprises B₄C, more particularly wherein the first component comprises SiC.

Item 48. The armor component of any one of items 38 to 47, wherein the first component comprises a woven material, wherein the first component comprises a non-woven material, wherein the first component comprises a fiber, wherein the first component comprises a para-aramid fiber, wherein the first component comprises ballistic fiber, wherein the ballistic fiber includes a natural fiber material, wherein the first component comprises a synthetic fiber material, wherein the ballistic fiber includes nylon.

Item 49. The armor component of any one of items 38 to 48, wherein the armor component includes a second component distinct from the first component and the material component, wherein the second component is a layer, wherein the material component is a layer, wherein the second component is overlying the material component, wherein the second component is underlying the material component, wherein the second component is abutting the material component, wherein the first component is overlying the second component, wherein the first component is underlying the second component, wherein the first component is abutting the second component, wherein the material component is disposed between the first component and the second component.

Item 50. The armor component of any one of items 38 to 49, wherein the first portion and the second portion are arranged in a predetermined distribution relative to each other, wherein the first portion defines a first ordered distribution within the second portion, wherein the second portion defines an ordered distribution within the first portion.

Item 51. The armor component of any one of items 38 to 50, wherein the first portion defines a first component and the second portion defines a second layer adjacent to the first component, overlying the first component, underlying the first component, abutting the first component, interwoven with the first component.

Item 52. The armor component of any one of items 38 to 51, wherein the first portion defines a two-dimensional shape selected from the group consisting of polygons, ellipsoids, circles, Roman numerals, Roman alphabet characters, Kanji characters, and a combination thereof.

Item 53. The armor component of any one of items 38 to 52, wherein the second portion defines a two-dimensional shape selected from the group consisting of polygons, ellipsoids, circles, Roman numerals, Roman alphabet characters, Kanji characters, and a combination thereof.

Item 54. The armor component of any one of the above items, wherein the material component includes a ceramic material.

Item 55. The armor component of any one of the above items, wherein the material component consists essentially of a ceramic material.

Item 56. A method for making an armor component, comprising: providing a material powder; and forming the material powder into a material component configured to undergo a phase change upon a projectile impact wherein the material component has a density of less than 3.7 g/cm³.

Item 57. The method of item 56, wherein forming the material powder into a material component comprises forming the material component in a ready state defining a transformation energy between a ready state and an absorbed state that is less than a predetermined projectile energy level.

Item 58. The method of item 56, wherein forming comprises sintering the material component to a density of at least 90% theoretical density.

Item 59. The method of item 56, wherein forming comprises mixing, molding, casting, depositing, pressing, punching, printing, spraying, drying, sintering, or a combination thereof.

Item 60. The method of item 56, wherein forming comprises reduced-pressure sintering of a green body including the material powder.

Item 61. The method of item 56, wherein sintering comprises reduced-pressure sintering.

Item 62. The method of item 56, wherein providing a material powder comprises providing a ceramic powder comprising a coating, wherein providing includes forming a coating on the ceramic powder, wherein the coating includes a material having a coefficient of thermal expansion (CTE) lower than a CTE of the ceramic powder.

Item 63. The method of item 62, wherein the coating comprises a material selected from the group consisting of ceramic, glass, polymer, natural material, and a combination thereof, wherein the coating comprises a material selected from the group consisting of oxides, nitrides, borides, carbides, and a combination thereof, wherein the coating comprises an oxide, wherein the coating comprises silicon, wherein the coating comprises silica, wherein the coating consists essentially of silica.

Item 64. The method of items 62 or 63, wherein the coating comprises a CTE of not greater than 3×10⁻⁶° C.⁻¹.

Item 65. The method of item 60, wherein forming the green body comprises deposition, pressing, casting, molding, printing, punching, mixing, or a combination thereof.

Item 66. The method of item 56, further comprising forming a mixture including the ceramic powder, wherein the mixture includes a wet mixture, wherein the mixture includes an additive, wherein the additive is selected from the group consisting of binders, plasticizers, surfactants, sintering aids, dispersants, and a combination thereof, wherein the mixture comprises a slurry, wherein the mixture comprises a pH of not greater than 12, not greater than 11, not greater than 10, wherein the mixture comprises a pH of at least 5, at least 6, at least 7, at least 8, at least 9.

Item 67. The method of item 66, wherein the sintering aid is selected from the group consisting of ceramic, glass, polymer, natural material, and a combination thereof, wherein the sintering aid comprises a material selected from the group consisting of oxides, nitrides, borides, carbides, and a combination thereof.

Item 68. The method of item 66, wherein the dispersant comprises a polymer, wherein the dispersant comprises ammonium polymethacrylate.

Item 69. The method of item 56, further comprising drying the mixture, wherein drying comprises freeze drying the mixture, wherein drying comprises spray drying.

Item 70. The method of items 60 or 65, wherein the green body comprises a shape selected from the group consisting of an standardized SAPI torso plate, a standardized tessellated tile, and a combination thereof.

Item 71. The method of items 62 or 66, further comprising hot-pressing the ceramic powder, wherein hot-pressing is conducted at a pressure of at least 20 MPa, at least 35 MPa, at least 70 MPa, at least 140 MPa, at least 210 MPa, and not greater than 690 MPa, not greater than 620 MPa, not greater than 520 MPa.

Item 72. The method of item 71, wherein hot-pressing is conducted at a pressing temperature of at least 1500° C., at least 1700° C., at least 1900° C., and not greater than 2200° C., not greater than 2100° C., not greater than 2000° C.

Item 73. The method of items 70 or 71, wherein hot-pressing is conducted in an inert atmosphere, wherein hot-pressing is conducted in an atmosphere comprising a free-carbon level of not greater than 500 ppm.

Item 74. The method of any one of items 56 to 73, wherein the material component includes a ceramic material.

Item 75. The method of item 74, wherein the material component consists essentially of a ceramic material.

### Examples

Three primary samples of armor components comprising a ceramic component made of hexagonal boron nitride were subjected to projectile impact. A first primary sample was made with boric oxide as a binder, had a density of about 2 g/cm³, a Knoop hardness measured at 1 kg load of about 20 Kg/mm² (corresponding to a Vickers hardness measured at 1 kg load of about 15 GPa), and a Young's modulus of about 47 GPa measured in the parallel direction and about 74 GPa measured in the perpendicular direction. The first primary sample consisted essentially of hexagonal boron nitride (h-BN). A second primary sample was made with calcium borate as a binder, had a density of about 2 g/cm³, a Knoop hardness of about 16 Kg/mm² (corresponding to a Vickers hardness of about 12 GPa), and a Young's modulus of about 40 GPa measured in the parallel direction and about 60 GPa measured in the perpendicular direction. The second primary sample consisted essentially of hexagonal boron nitride (h-BN). A third primary sample was made with about 54% h-BN, about 45% ZrO₂, about 10% borosilicate glass as a binder, had a density of about 2.9 g/cm³, a Knoop hardness measured at 1 kg load of about 100 Kg/mm² (corresponding to a Vickers hardness measured at 1 kg load of about 86 GPa), and a Young's modulus of about 71 GPa measured in both the perpendicular and parallel directions.

The three primary samples were formed into tiles having an intended strikeface and with a microstructure arranged to have the platelets of the hexagonal boron nitride grains stacked upon each other and with their basal planes oriented within 30° of parallel to the strikeface. The primary samples were subjected to projectile impacts on their respective strikefaces, and subsequently inspected. The primary sample tiles including hexagonal boron nitride defeated the projectiles in that the projectiles were at least partially, if not completely, comminuted.

Rubble from the three primary hexagonal boron nitride samples was tested using Archimedes density measurement, helium (He) pycnometry, and X-Ray powder diffraction (XRD). Archimedes density measurement was performed on large fragments obtained from the rubble of each sample. Helium pycnometer density measurement and X-ray diffraction spectra analysis were performed on smaller fragments sieved from the rubble.

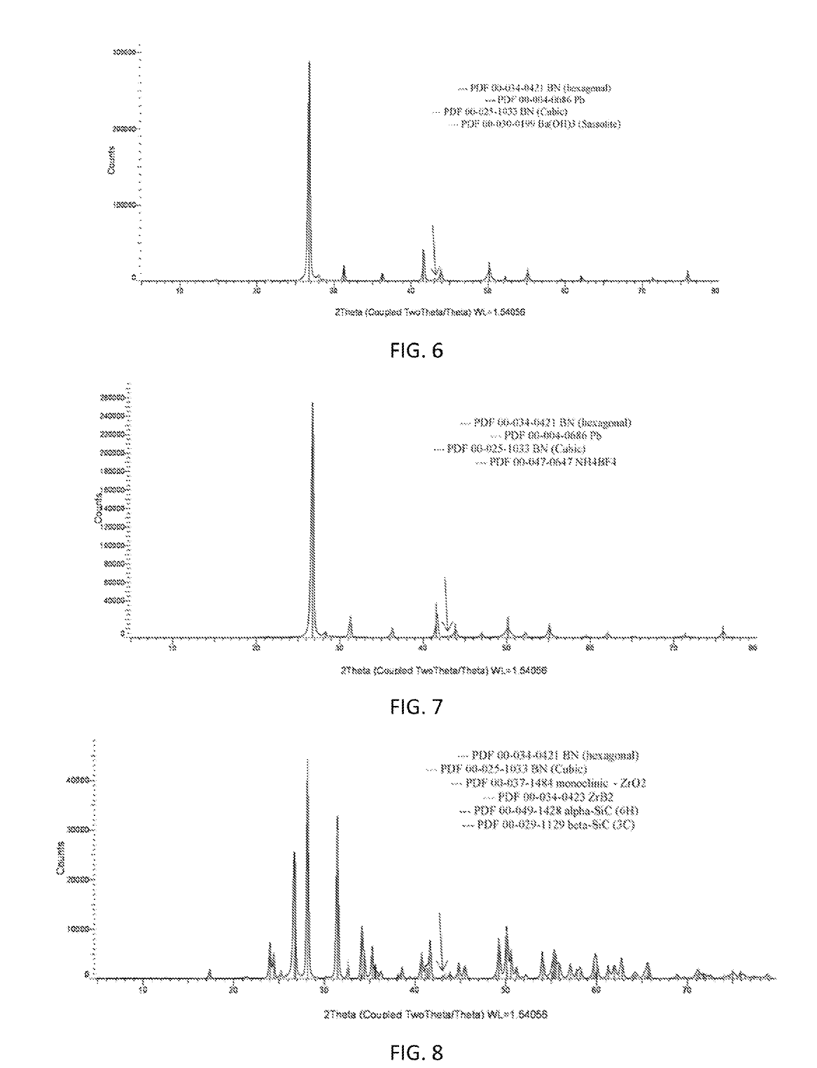

The results of the density measurements are shown below in Table 2, which also includes the specification densities for each sample before projectile impact. The results of the X-ray diffraction spectra analysis are shown in FIGS. 6-8, which correspond to the embodiments of the first, second, and third hexagonal boron nitride samples, respectively.

As shown below in Table 1, Archimedes densities and helium pycnometer densities are shown to be between approximately 10-40% higher than the original specification densities for each sample, with the exception of the Archimedes density measurement of the sample of FIG. 7.

TABLE 1

| Sample | FIG. 6 | FIG. 7 | FIG. 8 |
|---|---|---|---|
| Archimedes Density | 2.110 | 1.970 | 2.970 |
| (g/cm³) | | | |
| He Density (g/cm³) | 2.7961 | 2.558 | 3.267 |
| Spec. Density (g/cm³) | 2 | 2 | 2.9 |

As shown in FIGS. 6-8, the spectra analysis results indicate the presence of both hexagonal and cubic phases of boron nitride. Moreover, the spectra analysis results confirm that the higher densities measured from the rubble are at least in part due to the presence of a denser phase of boron nitride, e.g., cubic boron nitride.

Additional Ballistic Testing

Secondary samples were formed as the samples above, except that the microstructure of the tiles were arranged to have the platelets of the hexagonal boron nitride grains oriented substantially perpendicular to the strikeface. The secondary samples included tiles having thicknesses of 8 mm to 14 mm. The secondary samples were subjected to projectile impacts as the primary samples above, but the secondary samples failed to defeat the projectiles.

Further XRD analysis of the primary and secondary sample fragments

Fragments from the primary and secondary samples subjected to ballistic tests were further analyzed with XRD to determine grain orientation (i.e., platelet orientation) of the microstructure of the samples. The primary and secondary fragments were measured in the directions of the strikeface and a direction that is perpendicular to the strikeface.

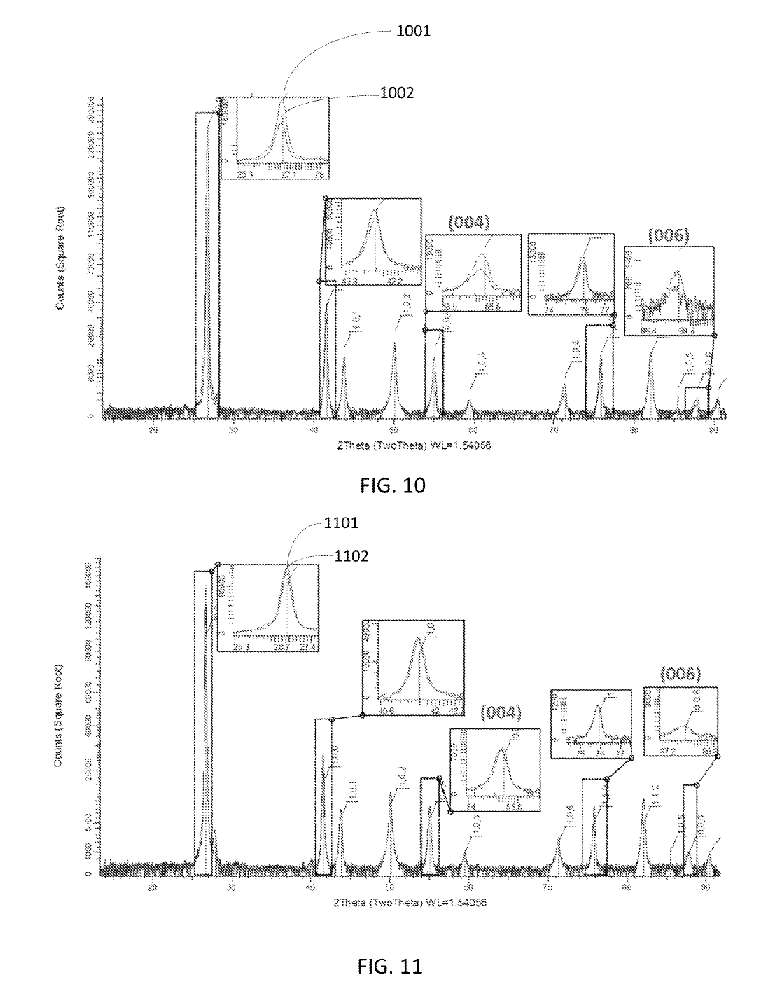

FIG. 10 is a graph illustrating the results of XRD analysis of the primary samples, which show a parallel platelet orientation peak 1001 with respect to the strikeface, and a perpendicular platelet orientation peak 1002 with respect to the strikeface. FIG. 11 is a graph illustrated the results of XRD analysis of the secondary samples, which show a parallel platelet orientation peak 1101 with respect to the strikeface, and a perpendicular platelet orientation peak 1102 with respect to the strikeface. As illustrated, the primary samples that were successful in defeating the projectile impacts had a larger amount of parallel oriented platelets than perpendicularly oriented platelets with respect to the strikeface, as indicated by the higher peak 1001 than peak 1002. Further, the secondary samples that were not successful in defeating the projectile impacts did not have a larger amount of parallel oriented platelets than perpendicularly oriented platelets with respect to the strikeface, as indicated by the respectively similar height of peak 1001 and peak 1002.

Generally, conventional armor components integrate ceramic materials for their hardness and density. However, contrary to conventional approaches, it was discovered, quite remarkably and unexpectedly, that the incorporation of particular ceramic components in accordance with the embodiments herein were as good as, or better than, conventional, hard ceramic materials. Although not wishing to be bound to any particular theory, it is believed that one or more of the features of the ceramic components of the embodiments herein facilitate their use as an armor component, including for example, an ability to transform phase upon projectile impact, hardness, elasticity, density, an ability to change lattice structure upon projectile impact, composite constructions, grain size, forming methods, body shape, coefficient of thermal expansion (CTE), and the like.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. As used herein, the phrase “consists essentially of” or “consisting essentially of” means that the subject that the phrase describes does not include any other components that may substantially affect the property of the subject.

Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Further, reference to values stated in ranges includes each and every value within that range.

As used herein, the phrase “average particle diameter” can be reference to an average, mean, or median particle diameter, also commonly referred to in the art as D50.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the scintillation and radiation detection arts.

In the foregoing, reference to specific embodiments and the connections of certain components is illustrative. It will be appreciated that reference to components as being coupled or connected is intended to disclose either direct connection between said components or indirect connection through one or more intervening components as will be appreciated to carry out the methods as discussed herein. As such, the above-disclosed subject matter is to be considered illustrative, and not restrictive, and the appended claims are intended to cover all such modifications, enhancements, and other embodiments, which fall within the true scope of the present invention. Moreover, not all of the activities described above in the general description or the examples are required, that a portion of a specific activity may not be required, and that one or more further activities can be performed in addition to those described. Still further, the order in which activities are listed is not necessarily the order in which they are performed.

The disclosure is submitted with the understanding that it will not be used to interpret or limit the scope or meaning of the claims. In addition, in the foregoing disclosure, certain features that are, for clarity, described herein in the context of separate embodiments, can also be provided in combination in a single embodiment. Conversely, various features that are, for brevity, described in the context of a single embodiment, can also be provided separately or in any subcombination. Still, inventive subject matter may be directed to less than all features of any of the disclosed embodiments.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, or essential feature of any or all the claims.

Thus, to the maximum extent allowed by law, the scope of the present invention is to be determined by the broadest permissible interpretation of the following claims and their equivalents, and shall not be restricted or limited by the foregoing detailed description.

What is claimed is:

1. An armor component comprising a body including a material component configured to undergo a phase change upon a projectile impact, wherein the material component has a density of not greater than 3.7 g/cm³.

2. The armor component of claim 1, wherein the material component has a density of at least 2.0 g/cm³.

3. The armor component of claim 1, wherein the material component has a strikeface, and wherein the material component has a thickness no greater than 100 mm, and is configured to prevent pentration of a projectile having an energy of 2500 J to 10000 J upon impact with the strikeface of the material component.

4. The armor component of claim 1, wherein the armor component has an areal density of no greater than 1 kg/cm².

5. The armor component of claim 1, wherein the material component has a strikeface, and includes a plurality of platelets stacked upon each other, the plurality of platelets include basal planes and at least 50% of the platelets within the plurality of platelets are oriented with their basal planes within 85° of parallel to the strikeface.

6. The armor component of claim 5, wherein the platelets have an average grain diameter of at least 0.3 microns and no greater than 10 microns.

7. The armor component of claim 5, wherein the strikeface is defined by an area of 0.5 cm².

8. The armor component of claim 5, wherein the strikeface lies substantially alone a single plane.

9. The armor component of claim 5, wherein at least 90% of the platelets within the plurality of platelets are oriented with their basal planes within 30° of parallel to the strikeface.

10. The armor component of claim 5, wherein the strikeface has a corresponding plane representative of the strikeface, and wherein at least 50% of the platelets within the plurality of platelets include basal planes oriented within 30° of parallel to the corresponding plane.

11. The armor component of claim 1, wherein the material component has a ready state defining a first lattice structure and configured to change from the ready state to an absorbed state defining a second lattice structure different from the first lattice structure.

12. The armor component of claim 1, wherein the material component has a ready state having a first density and configured to change from the ready state to an absorbed state having a second density, wherein the first density is less than the second density.

13. The armor component of claim 1, wherein the material component further comprise a transformation energy defined as a force configured to cause at least a portion of the material component to change from a ready state to an absorbed state, wherein the transformation energy is at least 1500 J and not greater than 10,000 J.

14. The armor component of claim 1, wherein the material component comprises a composite including a first material and a second material, wherein the first material defines a first material phase and the second material defines a second material phase, and wherein the first material phase and the second material phase are separate phases with respect to each other.

15. The armor component of claim 1, wherein the armor component is part of an article of clothing, a vehicle, a water-based vehicle, an aero-based vehicle, a building, a shield, or a combination thereof.

16. A method for making an armor component, comprising:
providing a material powder; and
forming the material powder into a material component configured to undergo a phase change upon a projectile impact wherein the material component has a density of less than 3.7 g/cm³.

17. The method of claim 16, wherein forming comprises reduced-pressure sintering of a green body including the material powder.

18. The method of claim 17, wherein the green body comprises a shape selected from the group consisting of an standardized SAPI torso plate, a standardized tessellated tile, and a combination thereof.

19. The method of claim 16, wherein forming comprises hot-pressing the powder.wherein hot-pressing is conducted at a pressure of at least 20 MPa.

20. The method of claim 19, wherein hot-pressing is conducted at a pressure of at least 20 MPa and at a pressing temperature of at least 1500° C.
